(19) United States
(12) Patent Application Publication
(10) Pub. No.: US 2014/0200868 A1
(43) Pub. Date: Jul. 17, 2014

(54) SEMIDEFINITE PROGRAMMING RELAXATION OF A CLASS OF ENERGY MANAGEMENT MODELS

(71) Applicant: Siemens Corporation, Iselin, NJ (US)

(72) Inventor: Alexis Motto, Princeton, NJ (US)

(73) Assignee: Siemens Corporation, Iselin, NJ (US)

(21) Appl. No.: 14/155,537

(22) Filed: Jan. 15, 2014

Related U.S. Application Data
(60) Provisional application No. 61/753,045, filed on Jan. 16, 2013.

(51) Int. Cl. G06F 17/50

(52) U.S. Cl. CPC G06F 17/5009
USPC 703/2

(57) ABSTRACT

According to an aspect of the invention, there is provided a method for optimizing a cost of electric power generation in a smart site energy management model, including determining a matrix X that minimizes a semidefinite program C·X−μ ln(det(X)) subject to constraints A^{BL}(X)=b^{BL}, A^{EG}(X)=b^{EG}, A^{IF}(X)=b^{IF}, X [symbol] 0, for positive real values of μ as μ approaches zero, wherein C·X is a cost function that models a smart building-grid energy, where C is a parameter matrix, X is a decision variable matrix, A^{BL}(X), A^{EG}(X), and A^{IF}(X) are sparse constraint matrices, b^{BL}, b^{EG}, and b^{IF} are constants derived from the constraints, and exploiting the sparsity of matrices A^{BL}(X), A^{EG}(X), and A^{IF}(X) in determining a search direction for determining the vector X.

### CROSS REFERENCE TO RELATED UNITED STATES APPLICATIONS

This application claims priority from “Semidefinite Programming (SDP) Relaxation of a Class of Energy Management Models”, U.S. Provisional Application No. 61/753,045 of Alexis Legbedji Motto, et al., filed Jan. 16, 2013, the contents of which are herein incorporated by reference in their entirety.

### TECHNICAL FIELD

This disclosure is directed to methods for the solution to a class of combined building-electric grid energy management models using a semidefinite programming (SDP) approach.

### DISCUSSION OF THE RELATED ART

A smart building-grid energy system is roughly defined as an interconnection of buildings and electric power grid energy resources within a clearly defined boundary, herein below called a smart site. A smart site is a strategic or self-interested entity that seeks to maximize some utility function subject to all applicable technical and budget constraints. The utility function is a measure of energy efficiency. A smart site may purchase energy from or sell energy to its external environment. On one hand, traditional building energy management systems have focused on meeting the energy requirements of one or more buildings assuming that the buildings are connected to a strong or infinite-capacity utility grid. On the other hand, electric grid management systems have traditionally modeled relatively large sites as single grid nodes with simple lump load models.

Modeling and solving the coordinated self-interested building and electric grid management models can help improve energy efficiency and security. From a practical perspective, global solutions to a general class of mathematical optimizations are of interest. Such optimization problems usually feature nonlinear constraints and many local minima. In most current works, local solutions are obtained using heuristic procedures.

From algorithmic perspective, the field of semidefinite programming (SDP) has received much interest in mathematical optimization in the last decade. SDP has applications in such diverse fields as traditional convex constrained optimization, control theory, and combinatorial optimization. Because SDPs are solvable via interior-point methods, and usually require about the same amount of computational resources as linear optimization, most applications can usually be efficiently solved in practice as well as in theory. There is interest in obtaining tight SDP relaxations of the building-grid energy management optimization and possibly exploiting the sparsity structure of the system.

### SUMMARY

Exemplary embodiments of the invention as described herein generally include systems and methods for solving a class of combined building-electric grid energy management models using a semidefinite programming (SDP) approach. A mathematical optimization model according to an embodiment of the disclosure is nonlinear, nonconvex and potentially large-scale. A model according to an embodiment of the disclosure does not assume an infinite-capacity grid, but rather includes the grid security constraints. An approach according to an embodiment of the invention includes formulating an energy management model using a polynomial approximation, adding valid linear matrix inequalities (LMIs) if necessary, deriving a convex relaxation of the management model to obtain lower bounds, and solving the ensuing model using a primal-dual interior-point method for semidefinite programming, possibly exploiting the sparsity of the model.

According to an aspect of the invention, there is provided a method for optimizing a cost of electric power generation in a smart site energy management model, including determining a matrix X that minimizes a semidefinite program C·X−μ ln(det(X)) subject to constraints

A^{BL}(X)=b^{BL},

A^{EG}(X)=b^{EG},

A^{IF}(X)=b^{IF},

X [symbol] 0,

for positive real values of μ as μ approaches zero, wherein C·X is a cost function that models a smart building-grid energy system of a plurality of buildings on a site interconnected with electric power grid energy resources wherein C is a matrix formed of parameters of components of a building model and an electric grid model, X is a matrix formed of decision variables of the building model and electric grid model, A^{BL}(X), A^{EG}(X), and A^{IF}(X) are sparse matrices that represent constraints due to a building (BL) model, an electric grid (EG) model, and an building-grid interface model (IF), respectively, in a semi-definite programming format, b^{BL}, b^{EG}, and b^{IF} are constants derived from the constraints of the building model and electric grid model, and exploiting the sparsity of matrices A^{BL}(X), A^{EG}(X), and A^{IF}(X) in determining a search direction for determining the vector X.

According to a further aspect of the invention, solving the primal semi-definite program includes imposing optimality conditions on the primal semi-definite program to derive

C−Z−Ã^{BL}(y^{BL})−Ã^{EG}(y^{EG})−Ã^{IF}(y^{IF})=0,

A^{BL}(X)−b^{BL}=0,

A^{EG}(X)−b^{EG}=0,

A^{IF}(X)−b^{IF}=0,

XZ−μI=0

wherein Z=μX⁻¹, X [symbol] 0, and Ã^{BL}(y^{BL}), Ã^{EG}(y^{EG}) and Ã^{IF}(y^{IF}) are transposes of A^{BL}(y^{BL}), A^{EG}(y^{EG}), and A^{IF}(y^{IF}) wherein y^{BL}, y^{EQ}, and y^{IF} are variables in a dual program of the primal semi-definite program, and choosing a search direction (ΔX, Δy, ΔZ) by solving

$$\tilde{A} Δ y = - \tilde{r} , \\ Δ Z = - {R}_{C} - {\sum }_{i ∈ {ℳ}_{b}} {A}_{bi}^{BL} Δ {y}_{i}^{BL} - {\sum }_{i ∈ {ℳ}_{e}} {A}_{i}^{EG} Δ {y}_{i}^{EG} - {\sum }_{i ∈ {ℳ}_{i}} {A}_{i}^{IF} Δ {y}_{i}^{IF} , \\ Δ X = ( K - W Δ Z ) W ,$$

wherein

$$W = {{X}^{\frac{1}{2}} ( {X}^{\frac{1}{2}} {ZX}^{\frac{1}{2}} )}^{- \frac{1}{2}} {X}^{\frac{1}{2}}$$

is a positive semidefinite symmetric matrix of order n, and

$$K = \frac{β}{n} ( X \cdot Z ) I - XZ$$

is an n×n real matrix that are determined by a current point (X, y, Z) for some β^{ε}(0,1), wherein

$$\tilde{A} = [ \begin{matrix}{\tilde{A}}^{BB} & {\tilde{A}}^{BE} & {\tilde{A}}^{BI} \\ {( {\tilde{A}}^{BE} )}^{T} & {\tilde{A}}^{EE} & {\tilde{A}}^{EI} \\ {( {\tilde{A}}^{BI} )}^{T} & {( {\tilde{A}}^{EI} )}^{T} & {\tilde{A}}^{II}\end{matrix} ] , {\tilde{r}}_{b} = [ \begin{matrix}{\tilde{r}}_{b}^{BL} \\ {\tilde{r}}_{b}^{EG} \\ {\tilde{r}}_{b}^{IF}\end{matrix} ] . , \\ {\tilde{A}}_{ij}^{BB} = {WA}_{i}^{BL} W \cdot {A}_{j}^{BL} , ∀ i , j ∈ {ℳ}^{BL} , \\ {\tilde{A}}_{ij}^{BE} = {WA}_{i}^{BL} W \cdot {A}_{j}^{EG} , ∀ i ∈ {ℳ}^{BL} , ∀ j ∈ {ℳ}^{EG} , \\ {\tilde{A}}_{ij}^{BI} = {WA}_{i}^{BL} W \cdot {A}_{j}^{IF} , ∀ i ∈ {ℳ}^{BL} , ∀ j ∈ {ℳ}^{IF} , \\ {\tilde{A}}_{ij}^{EE} = {WA}_{i}^{EG} W \cdot {A}_{j}^{EG} , ∀ i , j ∈ {ℳ}^{EG} , \\ {\tilde{A}}_{ij}^{EI} = {WA}_{i}^{EG} W \cdot {A}_{j}^{IF} , ∀ i ∈ {ℳ}^{EG} , ∀ j ∈ {ℳ}^{IF} , \\ {\tilde{A}}_{ij}^{II} = {WA}_{i}^{IF} W \cdot {A}_{j}^{IF} , ∀ i , j ∈ {ℳ}^{IF} , \\ {\tilde{r}}_{{b}_{i}}^{BL} = {r}_{{b}_{i}}^{BL} + ( K + {WR}_{C} ) W \cdot {A}_{i}^{BL} , ∀ i ∈ {ℳ}^{BL} , \\ {\tilde{r}}_{{b}_{i}}^{EG} = {r}_{{b}_{i}}^{EG} + ( K + {WR}_{C} ) W \cdot {A}_{i}^{EG} , ∀ i ∈ {ℳ}^{EG} , \\ {\tilde{r}}_{{b}_{i}}^{IF} = {r}_{{b}_{i}}^{IF} + ( K + {WR}_{C} ) W \cdot {A}_{i}^{IF} , ∀ i ∈ {ℳ}^{IF} .$$

and M^{BL}, M^{EG}, and M^{IF} denote index sets of building, electric-grid and building-grid interface constraints, respectively.

According to a further aspect of the invention, the method includes initializing a solution (X, y, Z) to an initial point (X⁰, y⁰, Z⁰) wherein X⁰ [symbol] 0,Z⁰ [symbol] 0, choosing a primal step length αₚ and a dual step length α_{d} that satisfy X+αₚΔX [symbol] 0 and Z+α_{d}ΔZ [symbol] 0, updating X←X+αₚΔX and (y, Z)←α_{d}(Δy, ΔZ), and repeating the steps of choosing a search direction, choosing a primal step length and a dual step length, and updating a current iterate (X, y, Z) until the current iterate satisfies a stopping condition.

According to a further aspect of the invention, the method includes enforcing linear independence constraint qualifications of the matrices Aᵢ^{BL}, for all iεM^{BL}, Aᵢ^{EG}, for all iεM^{EG}, and Aᵢ^{IF}, for all iεM^{IF}.

According to a further aspect of the invention, exploiting the sparsity of matrices A^{BL}(X), A^{EG}(X), and A^{IF}(X) includes counting a number ηᵢ^{BL}, ηᵢ^{EG}, ηᵢ^{IF} of nonzero elements in Aᵢ^{BL}, for all iεM^{BL}, Aᵢ^{EG}, for all iεM^{EG}, and Aᵢ^{IF}, for all iεM^{IF}, sorting the index sets M^{BL}, M^{EG}, M^{IF} in descending order in the numbers {ηᵢ^{BL}}, {ηᵢ^{EG}}, and {ηᵢ^{IF}} of nonzero elements in, respectively, Aᵢ^{BL}, for all iεM^{BL}, Aᵢ^{BG}, for all iεM^{EG}, and Aᵢ^{IF}, for all iεM^{IF}, computing CPU times d₁ᵢ^{BL}(î), d₂ᵢ^{BL}(î), and d₃ᵢ^{BL}(î) needed to compute Ã_{ξ(iK(j)}^{BB} for all i,jεM^{BL}, j≧i, wherein Ãᵢⱼ^{BB}=WAᵢ^{BL}W·Aⱼ^{BL}, ∀i,jεM^{BL}, and ξrepresents a permutation of the indices of the union of M^{BL}, M^{EG}, M^{IF}, computing CPU times d₁ᵢ^{EG}(î), d₂ᵢ^{EG}(î), and d₃ᵢ^{EG}(î) needed to compute Ã_{ξ(i)ξ(j)}^{EE}, for all i,jεM^{EG}, j≧i, wherein Ãᵢⱼ^{EE}=WAᵢ^{EG}W·Aⱼ^{EG}, ∀i,jεM^{EG}, computing CPU times d₁ᵢ^{IF}(î, d₂ᵢ^{IF}(î), and d₃ᵢ^{IGF}(î) needed to compute Ã_{ξ(i)ξ(j)}^{II}, for all i,jεM^{IF}, j≧i, wherein Ãᵢⱼ^{II}=WAᵢ^{IF}W·Aⱼ^{IF}, ∀i,jεM^{IF}, and determining indices q₁^{BL}, q₂^{BL}εM^{BL},q₁^{BL}≦q₂^{BL}, q₁^{EG}, q₂^{EG}εM^{EG}, q₁^{EG}≦q₂^{EG}, and q₁^{IF}, q₁^{IF}εM^{IF}, q₁^{IF}≦q₂^{IF} from conditions

d₁ᵢ^{BL}(ξ)≦d₂ᵢ^{BL}(ξ),d₁ᵢ^{BL}(ξ)≦d₃ᵢ^{BL}(ξ) if 0<i≦q₁^{BL},

d₂ᵢ^{BL}(ξ)<d₁ᵢ^{BL}(ξ),d₂ᵢ^{BL}(ξ)≦d₃ᵢ^{BL}(ξ) if q₁^{BL}<i≦q₂^{BL},

d₃ᵢ^{BL}(ξ)<d₁ᵢ^{BL}(ξ),d₃ᵢ^{BL}(ξ)<d₂ᵢ^{BL}(ξ) if q₂^{BL}<i≦|M^{BL}|,

d₁ᵢ^{EG}(ξ)≦d₂ᵢ^{EG}(ξ),d₁ᵢ^{EG}(ξ)≦d₃ᵢ^{EG}(ξ) if 0<i≦q₁^{EG},

d₂ᵢ^{EG}(ξ)<d₁ᵢ^{EG}(ξ),d₂ᵢ^{EG}(ξ)≦d₃ᵢ^{EG}(ξ) if q₁^{EG}<i≦q₂^{EG},

d₃ᵢ^{EG}(ξ)<d₁ᵢ^{EG}(ξ),d₃ᵢ^{EG}(ξ)<d₂ᵢ^{EG}(ξ) if q₂^{EG}<i≦|M^{EG}|,

d₁ᵢ^{IF}(ξ)≦d₂ᵢ^{IF}(ξ),d₁ᵢ^{IF}(ξ)≦d₃ᵢ^{IF}(ξ) if 0<i≦q₁^{IF},

d₂ᵢ^{IF}(ξ)<d₁ᵢ^{IF}(ξ),d₂ᵢ^{IF}(ξ)≦d₃ᵢ^{IF}(ξ) if q₁^{IF}<i≦q₂^{IF},

d₃ᵢ^{IF}(ξ)<d₁ᵢ^{IF}(ξ),d₃ᵢ^{IF}(ξ)<d₂ᵢ^{IF}(ξ) if q₂^{IF}<i≦|M^{IF}|,

According to a further aspect of the invention, ξ minimizes

$${d}_{*} ( ξ ) = {\sum }_{i ∈ {ℳ}^{BL}} {d}_{* i}^{BL} ( ξ ) + {\sum }_{j ∈ {ℳ}^{EG}} {d}_{* j}^{BL} ( ξ ) + {\sum }_{𝓁 ∈ {ℳ}^{IF}} {d}_{* 𝓁}^{BL} ( ξ ) .$$

for a permutation of a union of the index sets M^{BL}, M^{EG}, and M^{IF}.

According to a further aspect of the invention, if 0<i≦q₁^{BL}, the method further comprises computing

Ã_{ξ(i)ξ(j)}^{BB}=G^{BL}·A_{ξ(j)}^{BL},∀i,jεM^{BL},j≧i,

Ã_{ξ(i)ξ(j)}^{BE}=G^{BL}·A_{ξv(j)}^{EG},∀iεM^{BL},∀jεM^{EG},

Ã_{ξ(i)ξ(j)}^{BI}=G^{VL}·A_{ξ(j)}^{IF},∀iεM^{BL},∀jεM^{IF},

and if 0<i≦q₁^{IF}, the method further comprises computing comprises computing

Ã_{ξ(i)ξ(j)}^{II}=G^{IF}·A_{ξ(j)}^{IF},∀iεM^{EG},∀jεM^{IF},

According to a further aspect of the invention, if q₁^{BL}<i≦q₁^{BL}, the method further comprises computing

$${\tilde{A}}_{ξ ( i ) ξ ( j )}^{BB} = {\sum }_{α ∈ 𝒩} {\sum }_{β ∈ 𝒩} {[ {A}_{ξ ( j )}^{BL} ]}_{αβ} ( {\sum }_{γ ∈ 𝒩} {{W}_{αγ} [ {F}_{i}^{BL} ]}_{γβ} ) , \\ ∀ i , j ∈ {ℳ}^{BL} , j \geq i , \\ {\tilde{A}}_{ξ ( i ) ξ ( j )}^{BE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{EG} , \\ {\tilde{A}}_{ξ ( i ) ξ ( j )}^{BI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{IF} ,$$

if q₁^{EG}<i≦q₁^{EG}, the method further comprises computing

$${\tilde{A}}_{ξ ( i ) ξ ( j )}^{EE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{EG} ]}_{γβ} ) , \\ ∀ i , j ∈ {ℳ}^{EG} , j \geq i , \\ {\tilde{A}}_{ξ ( i ) ξ ( j )}^{EI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{EG} ]}_{γβ} ) , \\ ∀ i ∈ {ℳ}^{EG} , ∀ j ∈ {ℳ}^{IF} ,$$

and if q₁^{IF}<i≦q₁^{IF}, the method further comprises computing

$${\tilde{A}}_{ξ ( i ) ξ ( j )}^{II} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{IF} ]}_{γβ} ) , \\ ∀ i , j ∈ {ℳ}^{IF} , j \geq i .$$

According to a further aspect of the invention, if q₁^{BL}<i<M^{BL}, the method further comprises computing

$${\tilde{A}}_{ξ ( i ) ξ ( j )}^{BB} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{BL} ]}_{γε} , \\ ∀ i , j ∈ {ℳ}^{BL} , j \geq i , \\ {\tilde{A}}_{ξ ( i ) ξ ( j )}^{BE} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{EG} ]}_{γε} , \\ ∀ i ∈ {ℳ}^{BL} , ∀ j ∈ {ℳ}^{EG} , \\ {\tilde{A}}_{ξ ( i ) ξ ( j )}^{BI} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{IF} ]}_{γε} , \\ ∀ i ∈ {ℳ}^{BL} , ∀ j ∈ {ℳ}^{IF} ,$$

if q₁^{EG}<i<M^{EG}, the method further comprises computing

$${\tilde{A}}_{ξ ( i ) ξ ( j )}^{EE} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{EG} ]}_{γε} , \\ ∀ i , j ∈ {ℳ}^{EG} , j \geq i , \\ {\tilde{A}}_{ξ ( i ) ξ ( j )}^{EI} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{IF} ]}_{γε} , \\ ∀ i ∈ {ℳ}^{EG} , ∀ j ∈ {ℳ}^{IF} ,$$

and if q₁^{IF}<i<M^{IF}, the method further comprises computing

$${\tilde{A}}_{ξ ( i ) ξ ( j )}^{II} = {\sum }_{γ , ε ∈ 𝒩} {( {\sum }_{α , β ∈ 𝒩} {[ {A}_{ξ ( i )}^{IF} ]}_{αβ} {W}_{αγ} {W}_{βε} ) [ {A}_{ξ ( j )}^{IF} ]}_{γε} , \\ ∀ i , j ∈ {ℳ}^{IF} , j \geq i .$$

According to another aspect of the invention, there is provided a method for optimizing a cost of electric power generation in a smart site energy management model, including choosing a search direction (ΔX, Δy, ΔZ) to minimize a semi-definite program given by

C−Z−Ã^{BL}(y^{BL})−Ã^{EG}(y^{EG})−Ã^{IF}(y^{IF})=0,

A^{BL}(X)−b^{BL}=0,

A^{EG}(X)−b^{EG}=0

A^{IF}(X)−b^{IF}=0

XZ−μI=0

wherein C is a matrix formed of parameters of components of a building model and an electric grid model, X is a matrix formed of decision variables of the building model and electric grid model, A^{BL}(X), A^{EG}(X), and A^{IF}(X) are sparse matrices that represent constraints due to a building (BL) model, an electric grid (EG) model, and an building-grid interface model (IF), respectively, in a semi-definite programming format, b^{BL}, b^{EG}, and b^{IF} are constants derived from the constraints of the building model and electric grid model, Z=μX⁻¹, X [symbol] 0, and Ã^{BL}(y^{BL}), Ã^{EG}(y^{EG}) and Ã^{IF}(y^{IF}), are transposes of A^{BL}(y^{BL}), A^{EG}(y^{EG}), and A^{IF}(y^{IF}) wherein y^{BL}, y^{EQ}, and y^{IF} are variables in a dual program of the primal semi-definite program, by solving

$$\tilde{A} Δ y = - \tilde{r} , \\ Δ Z = - {R}_{C} - {\sum }_{i ∈ {ℳ}_{b}} {A}_{bi}^{BL} Δ {y}_{i}^{BL} - {\sum }_{i ∈ {ℳ}_{e}} {A}_{i}^{EG} Δ {y}_{i}^{EG} - {\sum }_{i ∈ {ℳ}_{i}} {A}_{i}^{IF} Δ {y}_{i}^{IF} , \\ Δ X = ( K - W Δ Z ) W ,$$

wherein

$$W = {{X}^{\frac{1}{2}} ( {X}^{\frac{1}{2}} {ZX}^{\frac{1}{2}} )}^{- \frac{1}{2}} {X}^{\frac{1}{2}}$$

is a positive semidefinite symmetric matrix of order n, and

$$K = \frac{β}{n} ( X \cdot Z ) I - XZ$$

is an n×n real matrix that are determined by a current point (X, y, Z) for some β^{ε} (0,1),

wherein

$$\tilde{A} = [ \begin{matrix}{\tilde{A}}^{BB} & {\tilde{A}}^{BE} & {\tilde{A}}^{BI} \\ {( {\tilde{A}}^{BE} )}^{T} & {\tilde{A}}^{EE} & {\tilde{A}}^{EI} \\ {( {\tilde{A}}^{BI} )}^{T} & {( {\tilde{A}}^{EI} )}^{T} & {\tilde{A}}^{II}\end{matrix} ] , {\tilde{r}}_{b} = [ \begin{matrix}{\tilde{r}}_{b}^{BL} \\ {\tilde{r}}_{b}^{EG} \\ {\tilde{r}}_{b}^{IF}\end{matrix} ] . , \\ {\tilde{A}}_{ij}^{BB} = {WA}_{i}^{BL} W \cdot {A}_{j}^{BL} , ∀ i , j ∈ {ℳ}^{BL} , \\ {\tilde{A}}_{ij}^{BE} = {WA}_{i}^{BL} W \cdot {A}_{j}^{EG} , ∀ i ∈ {ℳ}^{BL} , ∀ j ∈ {ℳ}^{EG} , \\ {\tilde{A}}_{ij}^{BI} = {WA}_{i}^{BL} W \cdot {A}_{j}^{IF} , ∀ i ∈ {ℳ}^{BL} , ∀ j ∈ {ℳ}^{IF} , \\ {\tilde{A}}_{ij}^{EE} = {WA}_{i}^{EG} W \cdot {A}_{j}^{EG} , ∀ i , j ∈ {ℳ}^{EG} , \\ {\tilde{A}}_{ij}^{EI} = {WA}_{i}^{EG} W \cdot {A}_{j}^{IF} , ∀ i ∈ {ℳ}^{EG} , ∀ j ∈ {ℳ}^{IF} , \\ {\tilde{A}}_{ij}^{II} = {WA}_{i}^{IF} W \cdot {A}_{j}^{IF} , ∀ i , j ∈ {ℳ}^{IF} , \\ {\tilde{r}}_{b}^{BL} = {r}_{b}^{BL} + ( K + {WR}_{C} ) W \cdot {A}_{i}^{BL} , ∀ i ∈ {ℳ}^{BL} , \\ {\tilde{r}}_{{b}_{i}}^{EG} = {r}_{{b}_{i}}^{EG} + ( K + {WR}_{C} ) W \cdot {A}_{i}^{EG} , ∀ i ∈ {ℳ}^{EG} , \\ {\tilde{r}}_{{b}_{i}}^{IF} = {r}_{{b}_{i}}^{IF} + ( K + {WR}_{C} ) W \cdot {A}_{i}^{IF} , ∀ i ∈ {ℳ}^{IF} .$$

and M^{BL}, M^{EG}, and M^{IF} denote index sets of building, electric-grid and building-grid interface constraints, respectively, and exploiting the sparsity of matrices A^{BL}(X), A^{EG}(X), and A^{IF}(X) in determining said search direction.

According to a further aspect of the invention, the semi-definite program is derived by imposing optimality conditions on a primal semi-definite program C·X−μ ln(det(X)) subject to constraints

A^{BL}(X)=b^{BL},

A^{EG}(X)=b^{EG},

A^{IF}(X)=b^{IF},

X [symbol] 0,

which is minimized for positive real values of μ as μ approaches zero.

According to another aspect of the invention, there is provided a non-transitory program storage device readable by a computer, tangibly embodying a program of instructions executed by the computer to perform the method steps for optimizing a cost of electric power generation in a smart site energy management model.

### BRIEF DESCRIPTION OF THE DRAWINGS

FIG. 1 illustrates a typical Combined Cooling, Heating and Power (CCHP) system, according to an embodiment of the invention.

FIGS. 2(a)-(b) illustrates up-to-eighth-order Taylor series approximations of the cos (x) and sin (x), respectively, over the theoretical range xε[−π,π], according to an embodiment of the invention.

FIG. 3 is a flowchart of a primal-dual interior point method for a convex relaxation of a class of combined building-electric grid energy management models using a semidefinite programming (SDP) approach, according to an embodiment of the invention.

FIG. 4 is a flowchart of a method for a convex relaxation of a class of combined building-electric grid energy management models using a semidefinite programming (SDP) approach that exploits sparsity, according to an embodiment of the invention.

FIG. 5 is a block diagram of an exemplary computer system for implementing a method for a convex relaxation of a class of combined building-electric grid energy management models using a semidefinite programming (SDP) approach, according to an embodiment of the invention.

### DETAILED DESCRIPTION OF EXEMPLARY EMBODIMENTS

Exemplary embodiments of the invention as described herein generally include systems and methods for a convex relaxation of a class of combined building-electric grid energy management models using a semidefinite programming (SDP) approach. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

NOTATION:

The notation used throughout the present disclosure is summarized in the NOMENCLATURE Appendix following this specification. The symbol Vₓh denotes the gradient of the function h with respect to x; Vₓ^{z}h denotes the Hessian of the function h with respect to x; x^{T} denote the transpose of x; tr(X) denotes the trace of X. The symbol Pᵣ(x) is shorthand for a polynomial function of x, of degree at most r. Most matrices occurring herein below will be real symmetric matrices of order n: Sⁿ denotes the space of such matrices. The notation x·y denotes the inner product of two equi-dimension vectors, defined by x^{T}y. The notation M₁·M₂ denotes the inner product between two such matrices, defined by tr(M₁M₂). The associated norm is the Frobenius norm, written ∥M∥_{F}:=(trM^{T}M)^{1/2} or just ∥M∥, while ∥M∥₂ denotes the L₂-operator norm of a matrix. Norms on vectors will always be Euclidean unless otherwise noted.

The notation X [symbol] 0 (X [symbol] 0) means that X is positive semidefinite (positive definite). The matrices involved in these binary operations are always symmetric matrices. The notation S₊ⁿ(S₊₊ⁿ) denotes the set of positive semidefinite (positive definite) symmetric matrices of order n. The notation Z [symbol] Y or Y [symbol] X means that Y−Z [symbol] 0. The notation X [symbol] Y or Y [symbol] X means that Y−X [symbol] 0. If X [symbol] 0, then write X^{1/2} for the square root of X.

The notation diag(X) denotes the vector of diagonal entries of X. X denotes the diagonal matrix with the vector x as its diagonal. This notation can be extended to general block diagonal matrices: if M₁, M₂, . . . , MₖεSⁿ, then diag(M₁, . . . , Mₖ) denotes the block diagonal matrix with the Mᵢ's on its diagonal. Lower-case Roman letters denote vectors and uppercase letters denote matrices.

Additional symbols used here are dual variables, which will be mnemonically displayed on top of the corresponding equality or inequality symbols. If x is a variable, then x and x̅ denote its lower limit and upper limit, respectively. Other symbols with a narrower scope are defined in the subsections where they are used. The symbol πᵢⱼₖ^{CH} denotes the i-th parameter of the j-th chiller (i.e. CH) at time step k, the symbol xᵢⱼₖ^{CH} denotes the i-th decision of the j-th chiller (i.e. CH) at time step k, and similarly for the other building-electric-grid resources; e.g. pump (PM); generator (GN), and node (ND). In particular, the letter k is a time index, and a parameter or variable subscripted by k means a measurement of the corresponding value at time k, and sums over k are sums over measurements of the corresponding subscripted term at times k.

Embodiments of the invention consider a small Combined Cooling, Heating and Power (CCHP) system that provides heating, cooling and electricity power to a single building or complex that has a group of several buildings. CCHP is a popular technology that integrates cooling, heating and power generation capabilities on one site. The keystone of CCHP is that waste heat from a prime mover, such as a gas turbine, can be utilized to meet a variety of thermal and power needs in the complex.

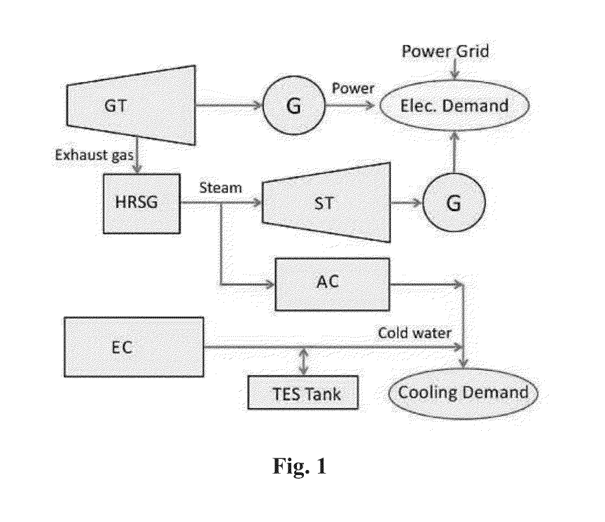

A schematic plot of an exemplary, non-limiting CCHP system is shown in FIG. 1. A gas turbine (GT) and generator (G) serve as the primary on-site source for electricity power. The waste heat in the exhaust gas from gas turbine is used to generate steam in heat recovery steam generator (HRSG) unit. Steam from the HRSG unit can either drive the absorption chiller (AC) to generate cooling, or drive a steam turbine (ST) to drive an additional electricity generator (G), or provide heating needs in the facility. Electric chillers (EC) and thermal energy storage (TES) tanks are also typical in such systems.

An electric grid (EG) can be modeled as a standard undirected graph G=(N, E), where N and E denote the sets of electric nodes and branches, respectively. A branch has two terminals: origin and destination terminals. Each terminal is connected to an electric node. Examples of electric branches are underground or overhead lines, on-load tap transformers, phase-shifting transformers, series reactors and series capacitors. In concept, generators, loads, and shunt devices, such as shunt capacitors and reactors, can be modeled as branch devices with one of their associated terminals connected to ground.

Optimization of a CCHP system is often performed on a steady state model, assuming that transients die out very fast. One exemplary, non-limiting model is a collection of reduced order models for components such as chillers, TES, HRSG, gas turbine for the purpose of optimization. According to an embodiment of the disclosure, a class of smart site energy management models, which are mathematical optimization models, may be defined by a minimization of an objective cost function given by EQ. (1), below, subject to the constraints of EQS. (2)-(11). A short description of the objective cost function and each of the constraints is given immediately following the last constraint; i.e. after EQS. (11). In the model equations below, the notation Pₖ refers to a k^{th}-order polynomial whose coefficients can be determined from a regression analysis. Note that these model equations are exemplary and non-limiting, and other embodiments of the invention can include other components models and other sets of constraints.

$$\begin{matrix}ζ = {\sum }_{k} \{ {\sum }_{g} {[ {ρ}_{gk}^{CG} \cdot {u}_{dgk}^{CG} ( {x}_{gk}^{CG} ) ]}^{2} + {\sum }_{c} {[ {ρ}_{ck}^{CH} \cdot {u}_{dck}^{CH} ( {x}_{ck}^{CH} ) ]}^{2} + {\sum }_{m} {[ {ρ}_{mk}^{CM} \cdot {u}_{dmk}^{CM} ( {x}_{mk}^{CM} ) ]}^{2} + {\sum }_{g} {[ {ρ}_{gk}^{GN} \cdot {u}_{dgk}^{GN} ( {x}_{gk}^{GN} ) ]}^{2} + {\sum }_{gl} {[ {ρ}_{gk}^{GT} \cdot {u}_{dgk}^{GT} ( {x}_{gk}^{GT} ) ]}^{2} + {\sum }_{h} {[ {ρ}_{hk}^{HR} \cdot {u}_{dhk}^{HR} ( {x}_{hk}^{HR} ) ]}^{2} + {\sum }_{l} {[ {ρ}_{lk}^{LD} \cdot {u}_{dlk}^{LD} ( {x}_{lk}^{LD} ) ]}^{2} + {\sum }_{n} {[ {ρ}_{nk}^{ND} \cdot {u}_{dnk}^{ND} ( {x}_{nk}^{ND} ) ]}^{2} + {\sum }_{p} {[ {ρ}_{pk}^{PM} \cdot {u}_{dpk}^{PM} ( {x}_{pk}^{PM} ) ]}^{2} + {\sum }_{s} {[ {ρ}_{sk}^{ST} \cdot {u}_{dsk}^{ST} ( {x}_{sk}^{ST} ) ]}^{2} + {\sum }_{t} {[ {ρ}_{tk}^{TE} \cdot {u}_{dtk}^{TE} ( {x}_{tk}^{TE} ) ]}^{2} + {\sum }_{t} {[ {ρ}_{tk}^{TS} \cdot {u}_{dtk}^{TS} ( {x}_{tk}^{TS} ) ]}^{2} \} , & ( 1 ) \\ {x}_{3 ck}^{CH} = {x}_{4 ck}^{CH} {π}_{3 wk}^{WR} ( {x}_{1 gk}^{CG} - {x}_{2 ck}^{CH} ) , & ( 2 a ) \\ {x}_{1 ck}^{CH} = {P}_{1} ( {x}_{3 ck}^{CH} ) , & ( 2 b ) \\ {x}_{7 tk}^{TS} = {x}_{2 gk}^{CG} - {x}_{1 mk}^{CM} & ( 3 a ) \\ {π}_{1 wk}^{WR} {π}_{3 wk}^{WR} \frac{d {x}_{1 tk}^{TS}}{d t} = {π}_{3 tk}^{TS} {x}_{7 tk}^{TS} {π}_{3 wk}^{WR} ( {x}_{2 tk}^{TS} - {x}_{1 tk}^{TS} ) + {π}_{7 tk}^{TS} {π}_{9 tk}^{TS} ( {x}_{2 tk}^{TS} - {x}_{1 tk}^{TS} ) & ( 3 b ) \\ {π}_{1 wk}^{WR} {π}_{3 wk}^{WR} \frac{d {x}_{2 tk}^{TS}}{d t} = {π}_{8 tk}^{TS} {x}_{7 tk}^{TS} {π}_{3 wk}^{WR} ( {x}_{3 tk}^{TS} - {x}_{2 tk}^{TS} ) + {π}_{7 tk}^{TS} {π}_{9 tk}^{TS} ( {x}_{1 tk}^{TS} - {x}_{2 tk}^{TS} ) & ( 3 c ) \\ {x}_{3 tk}^{TS} = {x}_{2 mk}^{CM} - {π}_{1 gk}^{CG} & ( 3 d ) \\ {x}_{7 tk}^{TS} {x}_{4 tk}^{TS} + {x}_{1 mk}^{CM} {x}_{3 mk}^{CM} = {x}_{2 gk}^{CG} {x}_{1 gk}^{CG} & ( 3 e ) \\ {x}_{7 tk}^{TS} = {x}_{1 mk}^{CM} - {x}_{2 gk}^{CG} & ( 4 a ) \\ {π}_{1 wk}^{WR} {π}_{3 wk}^{WR} \frac{d {x}_{1 tk}^{TS}}{d t} = {π}_{4 tk}^{TS} {x}_{7 tk}^{TS} {π}_{3 wk}^{WR} ( {x}_{6 tk}^{TS} - {x}_{1 tk}^{TS} ) + {π}_{5 tk}^{TS} {π}_{9 tk}^{TS} ( {x}_{2 tk}^{TS} - {x}_{1 tk}^{TS} ) & ( 4 b ) \\ {π}_{1 wk}^{WR} {π}_{3 wk}^{WR} \frac{d {x}_{2 tk}^{TS}}{d t} = {π}_{6 tk}^{TS} {x}_{7 tk}^{TS} {π}_{3 wk}^{WR} ( {x}_{1 tk}^{TS} - {x}_{2 tk}^{TS} ) + {π}_{5 tk}^{TS} {π}_{9 tk}^{TS} ( {x}_{1 tk}^{TS} - {x}_{2 tk}^{TS} ) & ( 4 c ) \\ {x}_{7 tk}^{TS} {x}_{5 tk}^{TS} + {x}_{2 gk}^{CG} {x}_{1 gk}^{CG} = {x}_{1 mk}^{CM} {x}_{2 mk}^{CM} & ( 4 d ) \\ {x}_{6 tk}^{TS} = {x}_{1 gk}^{CG} = {x}_{3 mk}^{CM} & ( 4 e ) \\ {x}_{7 tk}^{TS} = {P}_{1} ( {x}_{3 gk}^{GT} ) & ( 5 a ) \\ {x}_{1 gk}^{GT} = {P}_{2} ( {x}_{3 gk}^{GT} ) & ( 5 b ) \\ {x}_{2 gk}^{GT} = {P}_{4} ( {x}_{3 gk}^{GT} ) & ( 5 c ) \\ {x}_{3 hk}^{HR} = {P}_{1} ( {x}_{6 hk}^{HR} ) & ( 6 a ) \\ {x}_{2 wk}^{WR} = {P}_{1} ( {x}_{6 hk}^{HR} ) & ( 6 b ) \\ {x}_{5 hk}^{HR} = {π}_{1 hk}^{HR} {x}_{7 hk}^{HR} & ( 6 c ) \\ {x}_{2 gk}^{GT} - {x}_{4 hk}^{HR} = {π}_{2 hk}^{HR} ( {x}_{2 gk}^{GT} - {x}_{1 hk}^{HR} ) & ( 6 d ) \\ {\tilde{x}}_{3 gk}^{HR} {x}_{8 hk}^{HR} = {x}_{1 gk}^{GT} ( {x}_{2 gk}^{GT} - {x}_{4 hk}^{HR} ) & ( 6 e ) \\ {x}_{2 hk}^{HR} = \{ \begin{matrix}0 , & {\tilde{x}}_{3 gk}^{HR} < {\tilde{x}}_{1 gk}^{HR} \\ {x}_{3 hk}^{HR} + \frac{1}{{π}_{1 gk}^{GS}} ( {\tilde{x}}_{3 gk}^{HR} - {\tilde{x}}_{2 gk}^{HR} ) , & {\tilde{x}}_{3 gk}^{HR} \geq {\tilde{x}}_{2 gk}^{HR} \\ {x}_{3 hk}^{HR} , & o . w .\end{matrix} & ( 6 f , g , h ) \\ {\tilde{x}}_{1 gk}^{HR} = {π}_{3 wk}^{WR} ( {x}_{1 hk}^{HR} - {x}_{3 hk}^{HR} ) & ( 6 i ) \\ {\tilde{x}}_{2 gk}^{HR} = {π}_{3 wk}^{WR} ( {x}_{1 hk}^{HR} - {x}_{3 hk}^{HR} ) + {π}_{2 wk}^{WR} & ( 6 j ) \\ {x}_{2 sk}^{ST} = {x}_{3 sk}^{ST} {x}_{8 hk}^{HR} & ( 7 a ) \\ {x}_{4 mk}^{CM} = ( 1 - {x}_{3 sk}^{ST} ) {x}_{8 hk}^{HR} & ( 7 b ) \\ {π}_{1 wk}^{WR} {x}_{11 k}^{PM} = {x}_{2 sk}^{ST} ( {π}_{1 dk}^{DA} - {π}_{1 ck}^{CD} ) & ( 7 c ) \\ {x}_{12 k}^{PM} = \frac{{x}_{8 hk}^{HR}}{{π}_{1 wk}^{WR}} ( {x}_{7 hk}^{HR} - {π}_{1 dk}^{DA} ) & ( 7 d ) \\ {x}_{1 sk}^{ST} = {x}_{2 sk}^{ST} {π}_{1 gk}^{GS} {π}_{sk}^{ST} {x}_{2 hk}^{HR} ( 1 - {( {π}_{1 ck}^{CD} / {x}_{5 hk}^{HR} )}^{\frac{1}{4}} ) & ( 7 e ) \\ {x}_{1 tk}^{TE} = {π}_{1 tk}^{TE} {x}_{1 n ( t ) k}^{ND} {x}_{1 n ( t ) k}^{ND} + {x}_{1 n ( t ) k}^{ND} {x}_{1 n ( \tilde{t} ) k}^{ND} \{ {π}_{2 tk}^{TE} cos ( {x}_{1 n ( t ) k}^{ND} - {x}_{1 n ( \tilde{t} ) k}^{ND} ) + {π}_{4 tk}^{TE} sin ( {x}_{1 n ( t ) k}^{ND} - {x}_{1 n ( \tilde{t} ) k}^{ND} ) \} & ( 8 a ) \\ {x}_{2 tk}^{TE} = - {π}_{3 tk}^{TE} {x}_{1 n ( t ) k}^{ND} {x}_{1 n ( t ) k}^{ND} + {x}_{1 n ( t ) k}^{ND} {x}_{1 n ( \tilde{t} ) k}^{ND} \{ {π}_{2 tk}^{TE} sin ( {x}_{1 n ( t ) k}^{ND} - {x}_{1 n ( \tilde{t} ) k}^{ND} ) - {π}_{4 tk}^{TE} cos ( {x}_{1 n ( t ) k}^{ND} - {x}_{1 n ( \tilde{t} ) k}^{ND} ) \} & ( 8 b ) \\ {( {x}_{1 tk}^{TE} )}^{2} + {( {x}_{2 tk}^{TE} )}^{2} \leq {π}_{1 tk}^{TE} & ( 8 c ) \\ {\sum }_{\{ g \vert n ( g ) = n \}} {x}_{1 gk}^{GN} - {\sum }_{\{ 𝓁 \vert n ( 𝓁 ) = 𝓁 \}} {x}_{1 𝓁 k}^{LD} - {\sum }_{t \vert n ( t ) = n} {x}_{1 tk}^{TE} = 0 & ( 9 a ) \\ {\sum }_{\{ g \vert n ( g ) = n \}} {x}_{2 gk}^{GN} - {\sum }_{\{ 𝓁 \vert n ( 𝓁 ) = 𝓁 \}} {x}_{2 𝓁 k}^{LD} - {\sum }_{t \vert n ( t ) = n} {x}_{2 tk}^{TE} = 0 & ( 9 b ) \\ {\sum }_{c} {x}_{3 ck}^{CH} = {\sum }_{m} {x}_{3 mk}^{CM} , ∀ k & ( 10 a ) \\ {\sum }_{m} {x}_{5 mk}^{CM} + {\sum }_{g} {π}_{1 gk}^{GT} + {\sum }_{s} {x}_{1 sk}^{ST} = {\sum }_{m} {π}_{2 mk}^{CM} + {\sum }_{p} {x}_{1 pk}^{PM} + {\sum }_{c} {x}_{1 ck}^{CH} , ∀ k & ( 10 b ) \\ {\underline{x}}_{igk}^{CG} \leq {x}_{igk}^{CG} \leq {\overline{x}}_{igk}^{CG} , ∀ i , ∀ g , ∀ k & ( 11 a ) \\ {\underline{x}}_{ick}^{CH} \leq {x}_{ick}^{CH} \leq {\overline{x}}_{ick}^{CH} , ∀ i , ∀ c , ∀ k & ( 11 b ) \\ {\underline{x}}_{imk}^{CM} \leq {x}_{imk}^{CM} \leq {\overline{x}}_{imk}^{CM} , ∀ i , ∀ m , ∀ k & ( 11 c ) \\ {\underline{x}}_{igk}^{GN} \leq {x}_{igk}^{GN} \leq {\overline{x}}_{igk}^{GN} , ∀ i , ∀ g , ∀ k & ( 11 d ) \\ {\underline{x}}_{igk}^{GT} \leq {x}_{igk}^{GT} \leq {\overline{x}}_{igk}^{GT} , ∀ i , ∀ g , ∀ k & ( 11 e ) \\ {\underline{x}}_{ihk}^{HR} \leq {x}_{ihk}^{HR} \leq {\overline{x}}_{ihk}^{HR} , ∀ i , ∀ h , ∀ k & ( 11 f ) \\ {\underline{x}}_{i𝓁k}^{LD} \leq {x}_{i𝓁k}^{LD} \leq {\overline{x}}_{i𝓁k}^{LD} , ∀ i , ∀ 𝓁 , ∀ k & ( 11 g ) \\ {\underline{x}}_{ink}^{ND} \leq {x}_{ink}^{ND} \leq {\overline{x}}_{ink}^{ND} , ∀ i , ∀ n , ∀ k , & ( 11 h ) \\ {\underline{x}}_{ipk}^{PM} \leq {x}_{ipk}^{PM} \leq {\overline{x}}_{ipk}^{PM} , ∀ i , ∀ p , ∀ k & ( 11 i ) \\ {\underline{x}}_{isk}^{ST} \leq {x}_{isk}^{ST} \leq {\overline{x}}_{isk}^{ST} , ∀ i , ∀ s , ∀ k & ( 11 j ) \\ {\underline{x}}_{itk}^{TE} \leq {x}_{itk}^{TE} \leq {\overline{x}}_{itk}^{TE} , ∀ i , ∀ t , ∀ k & ( 11 k ) \\ {\underline{x}}_{itk}^{TS} \leq {x}_{itk}^{TS} \leq {\overline{x}}_{itk}^{TS} , ∀ i , ∀ t , ∀ k & ( 11 l )\end{matrix}$$

EQ. (1) defines an objective cost function to be minimized, where the symbols u_{gck}^{CG}(x_{gk}^{CG}), . . . , u_{dtk}^{TS}(xₜₖ^{TS}) denote basis vectors of at most d-degree polynomials, in the multi-dimensional arguments x_{gk}^{CG}, . . . , tₜₖ^{TS}, as defined below, e.g. in EQS. (12). According to an embodiment of the disclosure, a generic objective function may be assumed, which may be cast as a piecewise linear function or a sum of squares (SOS) polynomial. A polynomial pε [symbol] _{2d}[x] is an SOS polynomial if there exists k polynomials, [\tilde{p}ᵢ]ᵢ₌₁^{k}ε [symbol] [x], such that

$$p ( x ) = {\sum }_{i = 1}^{k} {{\tilde{p}}_{i} ( x )}^{2} .$$

Let S_{2d}[x] denote the set of SOS polynomial in x of degree at most 2d. For example, p(x₁, x₂)=(x₁²−2x₂−1)²+(2x₁x₂+x₁−5)² is an SOS polynomial of degree 4, with k=2, \tilde{p}(x₁,x₂)=x₁²−2x₂−1, and \tilde{p}₂(x₁,x₂)=2x₁x₂+x₁−5.

Note that a d-degree polynomial pε [symbol] _{d}[x] may be cast as p(x)=ρ^{T}u_{d}(x), where ρε [symbol] ^{|u}^{_{d}}^{|} is a vector of parameters, and u_{d}(x)ε [symbol] ^{|u}^{_{d}}^{|} is a basis vector of r-degree polynomials. The dimension of ρ and u(x) is given by

$$\vert {u}_{d} \vert = ( \begin{matrix}\vert x \vert + d \\ d\end{matrix} ) .$$

(i.e. the number of combinations of d in |x|+d). The vector u_{d}(x) may be expanded, in terms of the basis elements, as u_{d}(x)=vec{1, x₁, x₂, . . . , ₓn, x₁², x₁x₂, x₁x₃, . . . , xₙ², _ _ _, x₁^{r}, . . . , xₙ^{r}}. For example, if x^{ε} [symbol] ^{²} and p^{ε}P₂[x], one may have u₂(x₁, x₂, x₃)=vec{1, x₁, x₂, x₃, x₁², x₁x₂, x₁x₃, x₂², x₂x₃, x₃²}.

Using the aforementioned notation, a set of 2d-degree SOS polynomials according to an embodiment of the invention can be formally written as follows:

$${S}_{2 d} [ x ] = \{ {\sum }_{j = 1}^{k} {( {ρ}_{j}^{T} {u}_{d} ( x ) )}^{2} : k \geq 1 , {ρ}_{j} ∈ {( \begin{matrix}\vert x \vert + d \\ d\end{matrix} )}^{} \} \qquad ( 12 )$$

A smart site optimization model objective function according top an embodiment of the disclosure includes decomposable terms of subsets of building and/or electric grid model variables. In practice, only a small subset of variables typically appear in an objective function. Hence, the objective function parameters (i.e. ρⱼ's) are highly sparse. For example, the objective function to minimize the cost of electricity purchased from the external electric grid together with the cost of fuel used to power the gas turbine would be a linear function:

$$ζ = {\sum }_{k} \{ {\sum }_{m} {ρ}_{mk}^{CM} {x}_{mk}^{CM} + {\sum }_{g} {ρ}_{gk}^{GT} {x}_{gk}^{GT} \} . \qquad ( 13 )$$

In other energy management applications, the cost of generation may be expressed as a quadratic function in the power produced by the generators. It is well-known that any polynomial of degree 2 in xε [symbol] ^{|x|}, |x|≧1 can be cast as a sum of squares polynomials. In this case, the objective function may be a quadratic:

$$ζ = {\sum }_{k} {\sum }_{m} {[ {ρ}_{gk}^{GN} \cdot {u}_{dgk}^{GN} ( {x}_{gk}^{GN} ) ]}^{2} \qquad ( 14 )$$

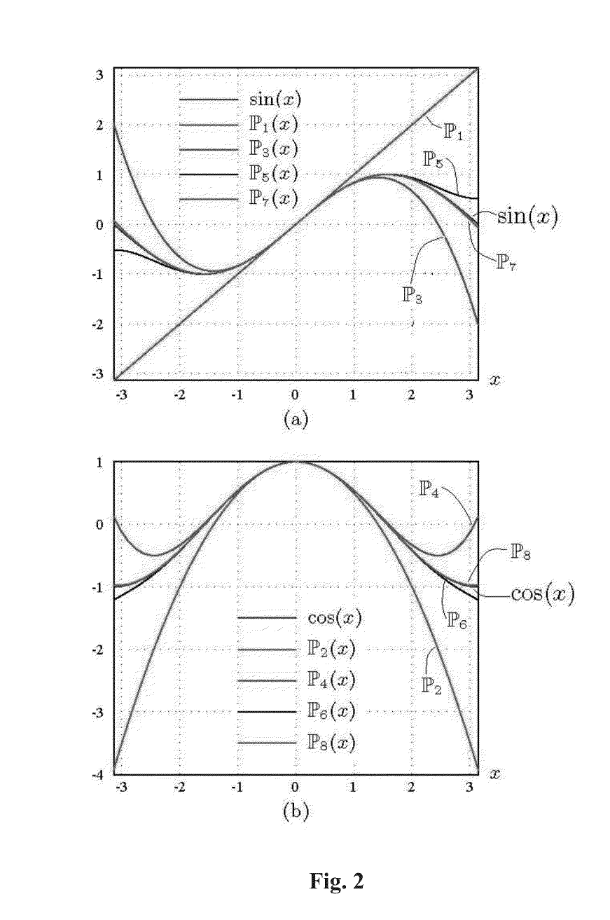

The constraints of EQ. (8a) define the real part of a power flow at terminal t at time k. The constraints of EQ. (8b) define the imaginary part of the power flow at terminal t at time k. The constraints of EQ. (8c) enforces the thermal rating at terminal t at time k. These constraints contain nonlinear terms involving the sine and cosine functions. According to an embodiment of the invention, these functions may be replaced by polynomial approximations using Taylor series expansions. FIGS. 2(a)-(b) shows the quality of this approximation over the practical angle range of xε[−π,π], the eighth order of which is highly-accurate for most realistic grid operation and planning modeling purposes. In practice, the node angle differences are sufficiently restricted such that lower order polynomial approximations may be appropriate, thereby decreasing the size of an optimization model according to an embodiment of the invention.

The constraints of EQS. (2a)-(2b) represent the Chiller (CH) Model: These equations describe a typical model according to an embodiment of the invention for chillers in a variable primary flow system. Under certain simplifying assumptions, the amount of cooling produced by a chiller is determined from chilled water mass flow rate through the chiller, expressed in EQ. (2a). The corresponding electricity consumption is determined by EQ. (2b).

The constraints of EQS. (3a)-(4e) represent the Thermal Storage (TS) Model: The following constraints describe a stratified, two-layered model according to an embodiment of the invention for thermal energy storage tank. EQS. (3) model the charging mode requirements. EQS. (4) enforce the discharge mode requirements. The thermodynamics of the two layers are described by a pair of ordinary differential equations; energy and mass conservation at mixing valves are included as equality constraints.

The constraints of EQS. (5a)-(5c) represent the Gas Turbine (GT) Model: EQS. (5) are data-driven models according to embodiments of the invention for selected input and outputs of the gas turbine, obtained through regression analysis. The input variable is the desired electrical power produced by the gas turbine. The output variables of interest are the corresponding values of natural gas mass flow rate, exhaust gas mass flow rate and turbine exit temperature.

The constraints of EQS. (6a)-(6j) represent the Heat Recovery Steam Generator (HR): The HRSG includes multiple components such as super-heater, economizer, boilers, etc. For simplicity of exposition, embodiments of the invention can model the HRSG as a lumped, counter-flow heat exchanger.

The constraints of EQS. (7a)-(7e) represent the Steam Loop: The steam loop may be defined as the section of the CCHP system associated with the co-generated steam used to meet heating demands and drive steam turbines for power production. A simplified model according to an embodiment of the invention for the steam loop is given by EQS. (7), where x₈ₕₖ^{HR} denotes the mass flow rate (kg/s) of steam used to drive steam turbine, and x₁ₛₖ^{ST} denotes the electrical power produced (MW) by steam turbine.

The constraints of EQS. (8a) and (8b) introduce hard nonlinearity and non-convexity into a feasible region of a grid management model according to an embodiment of the invention. However, note that these constraints exhibit sparsity, owing to the dependency of xₜₖ^{TE} on two 2-dimensional variables; that is, xₙ₍ₜ₎^{ND} and xₙ₍ₜ₎^{ND}.

The constraints of EQ. (9a) state that, for every node n, at every time k, the real part of the total power produced minus the real part of the total power consumed is equal to the net power injected to the electric grid. The constraints of EQS. (9b) state that, for every node n, at every time k, the imaginary part of the total power produced minus the imaginary part of the total power consumed is equal to the net power injected to the electric grid. Note that EQS. (9) are highly sparse since the degree of nodes in real-world electric grids is typically small, i.e., 1 to 5 branches per node.

The constraints of EQ. (10a) define the interface between the building and electric grid models. For example, it may be required that a campus or building group cooling load be satisfied by the operation of chillers at all times. The constraints of EQ. (10b) ensure that the electricity load on campus is satisfied by on-site generation and the power grid.

The constraints of EQS. (11a)-(11l) are Variable Constraints: All building model decision variables in according to embodiments of the invention are box constrained, in that they have lower and upper limits.

### Compact Model Formulation

A smart side energy management optimization model according to an embodiment of the disclosure can minimize the objective function of EQ. (1) subject to the constraints of EQS. (2)-(11). According to an embodiment of the disclosure, the aforementioned model may be recast using matrix vector notation. The matrices may be highly sparse for medium- to large-scale real-life smart site models. First, the various decision variables are packed into real vectors of appropriate dimensions:

x^{CG}=vec{x_{1gk}^{CG},x_{2gk}^{CG}}_{g,k} (15a)

x^{CH}=vec{x_{1ck}^{CH},x_{2ck}^{CH},x_{3ck}^{CH},x_{4ck}^{CH}}_{c,k} (15b)

x^{CM}=vec{x₁ₘₖ^{CM},x₂ₘₖ^{CM},x₃ₘₖ^{CM},x₄ₘₖ^{CM},x₅ₘₖ^{CM}}_{m,k} (15c)

x^{GN}=vec{x_{1gk}^{GN},x_{2gk}^{GN}}_{g,l} (15d)

x^{GT}=vec{x_{1gk}^{GT},x_{2gk}^{GT},x_{3gk}^{GT},x_{4gk}^{GT}}_{g,k} (15e)

x^{HR}=vec{x₁ₕₖ^{HR},x₂ₕₖ^{HR},x₃ₕₖ^{HR},x₄ₕₖ^{HR},x₅ₕₖ^{HR},x₆ₕₖ^{HR},x₇ₕₖ^{HR},x₈ₕₖ^{HR}}_{h,k} (15f)

x^{LD}=vec{x₁ₗₖ^{LD},x₂ₗₖ^{LD}}_{l,k} (15g)

x^{ND}=vec{x₁ₙₖ^{ND},x₂ₙₖ^{LD}}_{n,k} (15h)

x^{PM}=vec{x₁ₚₖ^{PM}}_{p,k} (15i)

x^{ST}=vec{x₁ₛₖ^{ST},x₂ₛₖ^{ST},x₃ₛₖ^{ST}}_{s,k} (15j)

x^{TE}=vec{x₁ₜₖ^{TE},x₂ₜₖ^{TE}}_{t,k} (15k)

x^{TS}=vec{x₁ₜₖ^{TS},x₂ₜₖ^{TS},x₃ₜₖ^{TS},x₄ₜₖ^{TS},x₅ₜₖ^{TS},x₆ₜₖ^{TS},x₇ₜₖ^{TS},x₈ₜₖ^{TS},x₉ₜₖ^{TS}}_{t,k} (15l)

Finally, decision variables of a smart site optimization model according to an embodiment of the disclosure are packed into a vector x with appropriate dimension:

x=vec{x^{CG},x^{CH},x^{CM},x^{GN},x^{GT},x^{HR},x^{LD},xₖ^{ND},x^{PM},x^{ST},x^{TE},x^{TS}} (16a)

According to an embodiment of the disclosure, projection matrices of appropriate dimensions, here denoted P*, may be used to obtain the aforementioned sub-vectors from x. For example, x^{GN}=P^{GN}x, and x^{TE}=P^{TE}x, where P^{GN} and P^{TE} are projection matrices. A smart site energy management model according to an embodiment of the disclosure can be cast compactly as follows:

$$\begin{matrix}{min}_{x} ζ ( x ) & ( 17 a ) \\ s . t . {P}^{BL} ( x ) = 0 & ( 17 b ) \\ {P}^{EG} ( x ) = 0 & ( 17 c ) \\ {P}^{IF} ( x ) = 0 & ( 17 d ) \\ \underline{x} \leq x \leq \overline{x} , & ( 17 e )\end{matrix}$$

where P^{BL}(x), P^{EG}(x), and P^{IF}(x) denote the sets of polynomials defining the building (BL) model constraints, the electric grid (EG) model constraints, and the building-grid interface model (IF) constraints, respectively:

P^{BL}(x)=vec{p₁^{BL}(x), . . . , pₘ_{_{b}}^{BL}(x)} (18a)

P^{EG}(x)=vec{p₁^{EG}(x), . . . , pₘ_{ₑ}^{EG}(x)} (18b)

P^{IF}(x)=vec{p₁^{IF}(x), . . . , pₘ_{ᵢ}^{IG}(x)} (18c)

where m_{b}, mₑ and mᵢ denote the number of building, electric grid and interface constraints, respectively. The constraints of EQS. (17b), (17c) and (17d) are equivalent to those of EQS. (2)-(7), (8)-(9), and (10), respectively. The constraints of EQ. (17e) are equivalent to those of EQ. (11). The objective function ζ is a linear or sum of squares polynomial in BL and EG decision variables.

According to an embodiment of the disclosure, the model is standardized to the following format:

$$\begin{matrix}{min}_{x} ζ ( x ) & ( 19 a ) \\ s . t . {P}^{BL} ( x ) = 0 & ( 19 b ) \\ {P}^{EG} ( x ) = 0 & ( 19 c ) \\ {P}^{IF} ( x ) = 0 & ( 19 d ) \\ x \geq 0. & ( 19 e )\end{matrix}$$

which may be equivalently derived from EQS. (17) using a following procedure: (i) change the reference variable: x←x−x, x̅−x; (ii) rewrite the ensuing inequality constraints x≦ x̅−x as equality constraints: x+s= x̅, where s≧0 is an auxiliary variable; (iii) append s to x; and (iv) append the new equality constraints to EQS. (19b) and (19c), as appropriate.

### Semidefinite Relaxation

### A. SDP Formulation

A smart site energy management model according to an embodiment of the disclosure as presented above is a nonlinear and non-convex optimization model, possibly with a disconnected feasibility set. The constraints defining the feasible region contain linear and nonlinear terms. Note that all nonlinear constraints in a smart side model may be cast as bilinear terms. This can be achieved by the addition of auxiliary variables wherever necessary. For example, the constraint of EQ. (5c) is equivalent to:

a₄x₂²+a₃x₂x₁+a₂x₁²+a₁x₁=b₁, (20a)

x₂=x₁². (20a)

EQS. (20) are equivalent to

$${( \begin{matrix}1 \\ {x}_{1} \\ {x}_{2}\end{matrix} )}^{T} [ \begin{matrix}0 & \frac{1}{2} {a}_{1} & 0 \\ \frac{1}{2} {a}_{1} & {a}_{2} & \frac{1}{2} {a}_{3} \\ 0 & \frac{1}{2} {a}_{3} & {a}_{4}\end{matrix} ] ( \begin{matrix}1 \\ {x}_{1} \\ {x}_{2}\end{matrix} ) = {b}_{1} , \qquad ( 20 c )$$

or, using the matrix inner product operator, to

$$[ \begin{matrix}0 & \frac{1}{2} {a}_{1} & 0 \\ \frac{1}{2} {a}_{1} & {a}_{2} & \frac{1}{2} {a}_{3} \\ 0 & \frac{1}{2} {a}_{3} & {a}_{4}\end{matrix} ] \cdot ( \begin{matrix}1 \\ {x}_{1} \\ {x}_{2}\end{matrix} ) {( \begin{matrix}1 \\ {x}_{1} \\ {x}_{2}\end{matrix} )}^{T} = {b}_{1} . \qquad ( 20 d )$$

The recast of EQ. (20b) to an equivalent form, using the matrix inner product operator, is immediate, following the previous example.

Applying the scheme in EQS. (20), according to an embodiment of the disclosure, a smart site energy management model may be rewritten as EQS. (21):

$$\begin{matrix}min C \cdot X & ( 21 a ) \\ s . t . {A}^{BL} ( X ) = {b}^{BL} & ( 21 b ) \\ {A}^{EG} ( X ) = {b}^{EG} & ( 21 c ) \\ {A}^{IF} ( X ) = {b}^{IF} & ( 21 d ) \\ X = [ \begin{matrix}1 & {x}^{T} \\ x & {xx}^{T}\end{matrix} ] & ( 21 e )\end{matrix}$$

where x denotes a real vector aggregating all aforementioned decision variables; A^{BL}(X), A^{EG}(X), and A^{IF}(X) reformulates the building (BL) model constraints, the electric grid (EG) model constraints, and the building-grid interface model (IF) constraints, respectively, in a semi-definite programming format:

A^{BL}(X)=vec{A₁^{BL}·X, . . . , Aₘ_{_{b}}^{BL}·X}, (22a)

A^{EG}(X)=vec{A₁^{EG}·X, . . . , Aₘ_{ₑ}^{EG}·X} (22b)

A^{IF}(X)=vec{A₁^{IF}·X, . . . , Aₘ_{ᵢ}^{IF}·X}, (22c)

where m_{b}, mₑ and mᵢ denote the number of building, electric grid and interface constraints, respectively. EQS. (21) are equivalent to EQS. (23):

min C·X (23a)

s.t. A^{BL}(X)=b^{BL} (23b)

A^{EG}(X)=b^{EG} (23c)

A^{IF}(X)=b^{IF} (23d)

X [symbol] 0 (23e)

rank(X)=1. (23f)

EQS. (23) are nonlinear and non-convex because of the rank condition on the matrix variable X. According to an embodiment of the disclosure, the rank condition on X may be relaxed. This leads to a convex relaxation of a smart site management model according to an embodiment of the disclosure. According to an embodiment of the disclosure, the ensuing model may be solved using an interior point method that exploits the sparsity structure.

### B. Solution Using Primal-Dual Interior Method

The algebra of a primal-dual interior point method for an SDP relaxation of a smart site energy management model according to an embodiment of the invention may be summarized below.

A relaxed primal SDP may be expressed as follows:

$$\begin{matrix}{min}_{X} C \cdot X & ( 24 a ) \\ s . t . {A}^{BL} ( X ) = {b}^{BL} & ( 24 b ) \\ {A}^{EG} ( X ) = {b}^{EG} & ( 24 c ) \\ {A}^{IF} ( X ) = {b}^{IF} & ( 24 d ) \\ X ≽ 0. & ( 24 e )\end{matrix}$$

The dual of EQS. (24) may be expressed as follows:

$$\begin{matrix}{min}_{y , Z} {b}^{BL} \cdot {y}^{BL} + {b}^{EG} \cdot {y}^{EG} + {b}^{IF} \cdot {y}^{IF} & ( 25 a ) \\ s . t . {\tilde{A}}^{BL} ( {y}^{BL} ) + {\tilde{A}}^{EG} ( {y}^{EG} ) + {\tilde{A}}^{IF} ( {y}^{IF} ) + Z = C & ( 25 b ) \\ Z ≽ 0. & ( 25 c )\end{matrix}$$

where Ã^{BL}(y^{BL}), Ã^{EG}(y^{EG}), and Ã^{IF}(y^{IF}) denote the transpose of A^{BL}(y^{BL}), A^{EG}(y^{EG}), and A^{IF}(y^{IF}):

$$\begin{matrix}{\tilde{A}}^{BL} ( y ) = {\sum }_{i = 1}^{{m}_{b}} {y}_{i} {A}_{i}^{BL} , & ( 26 a ) \\ {\tilde{A}}^{EG} ( y ) = {\sum }_{i = 1}^{{m}_{e}} {y}_{i} {A}_{i}^{EG} , & ( 26 b ) \\ {\tilde{A}}^{IF} ( y ) = {\sum }_{i = 1}^{{m}_{b}} {y}_{i} {A}_{i}^{IF} , & ( 26 c )\end{matrix}$$

where m_{b}, mₑ and mᵢ denote the number of building, electric grid and interface constraints, respectively.

Given a primal-dual feasible (X, y, Z), i.e. if X and (y, Z) are feasible for EQS. (24) and (25), respectively, the duality gap is:

C·X−b^{BL}·y^{BL}−b^{EG}·y^{EG}−b^{IF}·y^{IF}=X·Z≧0. (27)

where equality holds; i.e. Z·X=0, if and only if XZ=0.

A solution according to an embodiment of the disclosure includes solving the following parameterized SDP for a variety of positive real values μ as μ tends to zero:

$$\begin{matrix}{min}_{X} C \cdot X - μ ln ( det ( X ) ) & ( 28 a ) \\ s . t . {A}^{BL} ( X ) = {b}^{BL} & ( 28 b ) \\ {A}^{EG} ( X ) = {b}^{EG} & ( 28 c ) \\ {A}^{IF} ( X ) = {b}^{IF} & ( 28 d ) \\ X ≽ 0. & ( 28 e )\end{matrix}$$

where ln denotes the natural logarithm function. The optimality, or Karush-Kuhn-Tucker (KKT) conditions, for EQS. (28) are:

C−μX⁻¹−Ã^{BL}(y^{BL})−Ã^{EG}(y^{EG})−Ã^{IF}(y^{IF})=0, (29a)

A^{BL}(X)−b^{BL}=0 (29b)

A^{EG}(X)−b^{EG}=0 (29c)

A^{IF}(X)−b^{IF}=0 (29d)

X [symbol] 0. (29e)

According to an embodiment of the disclosure, define Z=μX⁻¹, which implies XZ=μI, and recast the KKT conditions as follows:

C−Z−Ã^{BL}(y^{BL})−Ã^{EG}(y^{EG})−Ã^{IF}(y^{IF})=0, (30a)

A^{BL}(X)−b^{BL}=0 (30b)

A^{EG}(X)−b^{EG}=0 (30c)

A^{IF}(X)−b^{IF}=0 (30d)

XZ−μI=0. (30e)

where X [symbol] 0.

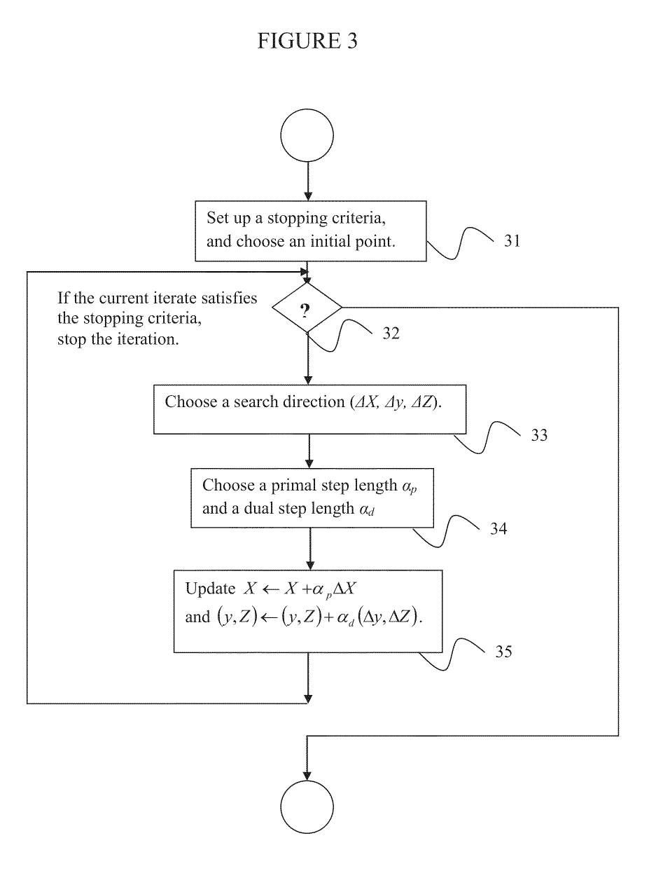

The nonlinear algebraic system of EQS. (30) can be solved using an appropriate Newton-like method. According to an embodiment of the invention, a method adapted from the following procedure may be used, with reference to the steps of the flowchart of FIG. 3:
(1) Set up a stopping criteria, and choose an initial point (X⁰, y⁰, Z⁰) such that X⁰ [symbol] 0 and Z⁰ [symbol] 0. Set (X, y, Z)←(X⁰, y⁰, Z⁰). (Step 31)
(2) If the current iterate (X, y, Z) satisfies the stopping criteria, stop the iteration. (Step 32)
(3) Choose a search direction (ΔX, Δy, ΔZ). (Step 33)
(4) Choose a primal step length αₚ and a dual step length α_{d} such the following conditions hold (Step 34):

X+αₚΔX [symbol] 0, (31a)

Z+α_{d}ΔZ [symbol] 0. (31b)
(5) Update the variables (Step 35):

X←X+αₚΔX, (32a)

(y,Z)←(y,Z)+α_{d}(Δy,ΔZ). (32b)
(6) Go to step 2.

According to an embodiment of the disclosure, the search direction (ΔX, Δy, ΔZ) can be determined by solving the following algebraic system:

ΔZ+Ã^{BL}(Δy^{BL})+Ã^{EG}(Δy^{EG})+Ã^{IF}(Δy^{IF})=−R_{C}, (33a)

A^{BL}(ΔX)=−ₚ^{BL} (33b)

A^{EG}(ΔX)=−rₚ^{EG} (33c)

A^{IF}(ΔX)=−rₚ^{IF} (33d)

Hₚ(ΔXZ+XΔZ)=−R_{d} (33e)

where

σε[0,1], (34a)

R_{C}=Ã^{BL}(Δy^{BL})+Ã^{EG}(Δy^{EG})+Ã^{IF}(Δy^{IF})+ΔZ−C, (34b)

rₚ^{BL}=A^{BL}(X)−b^{BL}, (34c)

rₚ^{EG}=A^{EG}(X)−b^{EG}, (34d)

rₚ^{IF}=A^{IF}(X)−b^{IF}, (34e)

r_{d}=H_{P}(XZ)−σμI (34f)

and H_{P} is a symmetrization operator, for some regular matrix P, which ensures that XZ is symmetric at every iterate. For example, P=Z^{1/2} and P=I yields:

$$\begin{matrix} {H}_{P} ( XZ ) = \frac{1}{2} ( {PXZP}^{- 1} + {( {PXZP}^{- 1} )}^{T} ) , & ( 35 a ) \\ {H}_{P} ( Δ XZ + X ΔZ ) = \frac{1}{2} ( P ( Δ XZ + X Δ Z ) {P}^{- 1} + {( P ( Δ XZ + X Δ Z ) {P}^{- 1} )}^{T} ) . & ( 35 b )\end{matrix}$$

### C. Exploiting Sparsity

A computationally intensive step in an interior-point method for semidefinite programming is the calculation of the Newton direction. According to an embodiment of the invention, exploiting the sparsity of the data matrices and/or adaptively ignoring unnecessary constraints may result in reducing the computational cost of each iteration, thus increasing overall computational performance.

Let M^{BL}, M^{EG}, and M^{IF} denote the index sets of building, electric-grid and building-grid interface constraints, respectively. Let M^{BL} be shorthand for the union of M^{BL}, M^{EG}, and M^{IF}. The matrices Aᵢ^{BL}, for all iεM^{BL}, Aᵢ^{EG}, for all iεM^{EG}, and Aᵢ^{IF}, for all iεM^{IF}, are sparse. For numerically efficiency, especially in large-scale instances of a smart site optimization model according to an embodiment of the invention, embodiments may exploit the sparsity structure of the data in the solution procedure. This can be achieved in the computation of the primal/dual search direction; that is, in step 3 of a procedure according to an embodiment of the invention as outlined above. There are many ways of obtaining the search direction. According to embodiments of the invention, the search direction introduced by Nesterov and Todd, “Primal-dual interior-point methods for self-scaled cones,” SIAM Journal on Optimization, Vol. 8, No. 2, pp. 324-364, 1998, the contents of which are herein incorporated by reference in their entirety, is used, adapting the derivation by Fujisawa, et al., “Exploiting sparsity in primal dual interior-point methods for semidefinite programming,” Mathematical Programming, Vol. 79, No. 1, pp. 235-253, 1997, the contents of which are also herein incorporated by reference in their entirety.

According to an embodiment of the disclosure, the search direction may be obtained as a solution (ΔX, Δy, ΔZ) of the following nonlinear algebraic system:

$$\begin{matrix} {A}_{i}^{BL} \cdot Δ X = {r}_{i}^{BL} , ∀ i ∈ {M}^{BL} , & ( 36 a ) \\ {A}_{i}^{EG} \cdot Δ X = {r}_{i}^{EG} , ∀ i ∈ {M}^{EG} , & ( 36 b ) \\ {A}_{i}^{IF} \cdot Δ X = {r}_{i}^{IF} , ∀ i ∈ {M}^{IF} , & ( 36 c ) \\ {\sum }_{i ∈ {ℳ}_{b}} {A}_{bi}^{BL} Δ {y}_{i}^{BL} + {\sum }_{i ∈ {ℳ}_{e}} {A}_{i}^{EG} Δ {y}_{i}^{EG} + {\sum }_{i ∈ {ℳ}_{i}} {A}_{i}^{IF} Δ {y}_{i}^{IF} + Δ Z = - {R}_{C} , & ( 36 d ) \\ Δ {XW}^{- 1} + W Δ Z = K , & ( 36 e )\end{matrix}$$

where WεSⁿ and Kε [symbol] ^{n×n} are determined by the current point (X, y, Z) of the system of EQS. (36):

$$\begin{matrix}W = {{X}^{\frac{1}{2}} ( {X}^{\frac{1}{2}} {ZX}^{\frac{1}{2}} )}^{- \frac{1}{2}} {X}^{\frac{1}{2}} & ( 37 a ) \\ K = \frac{β}{n} ( X \cdot Z ) I - XZ , & ( 37 b )\end{matrix}$$

for some βε(0,1).

According to an embodiment of the disclosure, to ensure that EQS. (36) has a unique solution, it suffices to enforce the linear independence constraint qualification (LICQ) of the matrices Aᵢ^{BL}, for all iεM^{BL}, Aᵢ^{BG}, for all iεM^{EG}, and Aᵢ^{IF}, for all iεM^{IF}. The LICQ can be enforced during a presolution stage using any standard method for eliminating redundant constraints.

According to an embodiment of the disclosure, EQS. (36) may be recast as follows:

$$\begin{matrix} \tilde{A} Δ y = - \tilde{r} , & ( 38 a ) \\ Δ Z = - {R}_{C} - {\sum }_{i ∈ {ℳ}_{b}} {A}_{bi}^{BL} Δ {y}_{i}^{BL} - {\sum }_{i ∈ {ℳ}_{e}} {A}_{i}^{EG} Δ {y}_{i}^{EG} - {\sum }_{i ∈ {ℳ}_{i}} {A}_{i}^{IF} Δ {y}_{i}^{IF} , & ( 38 b ) \\ Δ X = ( K - W Δ Z ) W , & ( 38 c )\end{matrix}$$

where the matrix Ã and the vector \tilde{r} are partitioned as follows:

$$\tilde{A} = [ \begin{matrix}{\tilde{A}}^{BB} & {\tilde{A}}^{BE} & {\tilde{A}}^{BI} \\ {( {\tilde{A}}^{BE} )}^{T} & {\tilde{A}}^{EE} & {\tilde{A}}^{EI} \\ {( {\tilde{A}}^{BI} )}^{T} & {( {\tilde{A}}^{EI} )}^{T} & {\tilde{A}}^{II}\end{matrix} ] , {\tilde{r}}_{b} = [ \begin{matrix}{\tilde{r}}_{b}^{BL} \\ {\tilde{r}}_{b}^{EG} \\ {\tilde{r}}_{b}^{IF}\end{matrix} ] . \qquad ( 39 a )$$

The elements of the submatrices of Ã, and the elements of the subvectors of \tilde{r}, are given as follows:

Ãᵢⱼ^{BB}=WAᵢ^{BL}W·Aⱼ^{BL},∀i,jεM^{BL}, (40a)

Ãᵢⱼ^{BL}=WAᵢ^{BL}W·Aⱼ^{EG},∀iεM^{BL},∀jεM^{EG}, (40b)

Ãᵢⱼ^{BI}=WAᵢ^{BL}W·Aⱼ^{IF},∀iεM^{BL},∀jεM^{IF}, (40c)

Ãᵢⱼ^{EE}=WAᵢ^{EG}W·Aⱼ^{EG},∀i,jεM^{EG}, (40d)

Ãᵢⱼ^{EI}=WAᵢ^{EG}W·Aⱼ^{IF},∀iεM^{EG},∀jεM^{IF}, (40e)

Ãᵢⱼ^{II}=WAᵢ^{IF}W·Aⱼ^{IF},∀i,jεM^{IF}, (40f)

\tilde{r}_{b}_{ᵢ}^{BL}=r_{b}_{ᵢ}^{BL}+(K+WR_{C})W·Aᵢ^{BL},∀iεM^{BL}, (40g)

\tilde{r}_{b}_{ᵢ}^{EG}=r_{b}_{ᵢ}^{EG}+(K+WR_{C})W·Aᵢ^{EG},∀iεM^{EG}, (40h)

\tilde{r}_{b}_{ᵢ}^{IF}=r_{b}_{ᵢ}^{IF}+(K+WR_{C})W·Aᵢ^{IF},∀iεM^{IF}. (40i)

The matrices X, Z and A are symmetric and dense even when Aᵢ^{BL}, for all iεM^{BL}, Aᵢ^{EG}, for all iεM^{EG}, and Aᵢ^{IF}, for all iεM^{IF}, are sparse. Thus, solving the algebraic system of EQS. (38) for (ΔX, Δy, ΔZ), using a Cholesky factorization method, is CPU-intensive. In a worst case, this would involve O(m³)+O(n³) arithmetic operations, where m and n denote the number of rows of A and X, respectively. However, according to embodiments of the invention, computing Ã and \tilde{r} using EQS. (40) uses, in the worst case, O(mn²+m²n²) and O(n³+mn²) arithmetic operations, respectively. The computation of Ã is the most CPU intensive part of the solution process for obtaining the search direction (ΔX, Δy, ΔZ).

Let ηᵢ^{BL}, ηᵢ^{EG}, and ηᵢ^{IF} denote the number of nonzero elements in Aᵢ^{BL}, Aᵢ^{EG}, and Aᵢ^{IF}, respectively. Let Ξ^{BL}, Ξ^{EG}, and Ξ^{IF} denote the set of permutations of the index sets M^{BL}, M^{EG}, and M^{IF}, respectively. Let Ξ denote the union of Ξ^{BL}, Ξ^{EG}, and Ξ^{IF}. Let ξ denote some element of Ξ; that is, ξ is a permutation of the index set defined by the union of M^{BL}, M^{EG}, and M^{IF}. According to embodiments of the disclosure, the elements of the matrix Ã can be computed using one of the sets of following EQS. (42), (43), or (44). These equations make more efficient usage of computer resources, such as CPU time usage, memory usage, disk usage, and network usage. This generalization can be achieved by estimating, off-line, the efficiency of computing the elements of the matrix Ã.

$$\begin{matrix}{F}_{i}^{BL} = {A}_{ξ ( i )}^{BL} W , ∀ i ∈ {ℳ}^{BL} , & ( 41 a ) \\ {F}_{i}^{EG} = {A}_{ξ ( i )}^{EG} W , ∀ i ∈ {ℳ}^{EG} , & ( 41 b ) \\ {F}_{i}^{IF} = {A}_{ξ ( i )}^{IF} W , ∀ i ∈ {ℳ}^{IF} , & ( 41 c ) \\ {G}_{i}^{BL} = {WF}_{i}^{BL} , ∀ i ∈ {ℳ}^{BL} , & ( 41 d ) \\ {G}_{i}^{EG} = {WF}_{i}^{EG} , ∀ i ∈ {ℳ}^{EG} , & ( 41 e ) \\ {G}_{i}^{IF} = {WF}_{i}^{IF} , ∀ i ∈ {ℳ}^{IF} . & ( 41 f ) \\ {\tilde{A}}_{ξ ( i ) ξ ( j )}^{BB} = {G}^{BL} \cdot {A}_{ξ ( j )}^{BL} , ∀ i , j ∈ {ℳ}^{BL} , j \geq i , & ( 42 a ) \\ {\tilde{A}}_{ξ ( i ) ξ ( j )}^{BE} = {G}^{BL} \cdot {A}_{ξ ( j )}^{EG} , ∀ i ∈ {ℳ}^{BL} , ∀ j ∈ {ℳ}^{EG} , & ( 42 b ) \\ {\tilde{A}}_{ξ ( i ) ξ ( j )}^{BI} = {G}^{BL} \cdot {A}_{ξ ( j )}^{IF} , ∀ i ∈ {ℳ}^{BL} , ∀ j ∈ {ℳ}^{IF} , & ( 42 c ) \\ {\tilde{A}}_{ξ ( i ) ξ ( j )}^{EE} = {G}^{EG} \cdot {A}_{ξ ( j )}^{EG} , ∀ i , j ∈ {ℳ}^{EG} , j \geq i , & ( 42 d ) \\ {\tilde{A}}_{ξ ( i ) ξ ( j )}^{EI} = {G}^{EG} \cdot {A}_{ξ ( j )}^{IF} , ∀ i ∈ {ℳ}^{EG} , ∀ j ∈ {ℳ}^{IF} , & ( 42 e ) \\ {\tilde{A}}_{ξ ( i ) ξ ( j )}^{II} = {G}^{IF} \cdot {A}_{ξ ( j )}^{IF} , ∀ i , j ∈ {ℳ}^{IF} , j \geq i . & ( 42 f ) \\ {\tilde{A}}_{ξ ( i ) ξ ( j )}^{BB} = {\sum }_{α ∈ 𝒩} {\sum }_{β ∈ 𝒩} {[ {A}_{ξ ( j )}^{BL} ]}_{αβ} ( {\sum }_{γ ∈ 𝒩} {{W}_{αγ} [ {F}_{i}^{BL} ]}_{γβ} ) , \\ ∀ i , j ∈ {ℳ}^{BL} , j \geq i , & ( 43 a ) \\ {\tilde{A}}_{ξ ( i ) ξ ( j )}^{BE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{EG} , & ( 43 b ) \\ {\tilde{A}}_{ξ ( i ) ξ ( j )}^{BI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{IF} , & ( 43 c ) \\ {\tilde{A}}_{ξ ( i ) ξ ( j )}^{EE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{EG} ]}_{γβ} ) , \\ ∀ i , j ∈ {ℳ}^{EG} , j \geq i , & ( 43 d ) \\ {\tilde{A}}_{ξ ( i ) ξ ( j )}^{EI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{EG} ]}_{γβ} ) , \\ ∀ i ∈ {ℳ}^{EG} , ∀ j ∈ {ℳ}^{IF} , & ( 43 e ) \\ {\tilde{A}}_{ξ ( i ) ξ ( j )}^{II} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{IF} ]}_{γβ} ) , \\ ∀ i , j ∈ {ℳ}^{IF} , j \geq i . & ( 43 f ) \\ {\tilde{A}}_{ξ ( i ) ξ ( j )}^{BB} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{BL} ]}_{γε} , \\ ∀ i , j ∈ {ℳ}^{BL} , j \geq i , & ( 44 a ) \\ {\tilde{A}}_{ξ ( i ) ξ ( j )}^{BE} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{EG} ]}_{γε} , \\ ∀ i ∈ {ℳ}^{BL} , ∀ j ∈ {ℳ}^{EG} , & ( 44 b ) \\ {\tilde{A}}_{ξ ( i ) ξ ( j )}^{BI} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{IF} ]}_{γε} , \\ ∀ i ∈ {ℳ}^{BL} , ∀ j ∈ {ℳ}^{IF} , & ( 44 c ) \\ {\tilde{A}}_{ξ ( i ) ξ ( j )}^{EE} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{EG} ]}_{γε} , \\ ∀ i , j ∈ {ℳ}^{EG} , j \geq i , & ( 44 d ) \\ {\tilde{A}}_{ξ ( i ) ξ ( j )}^{EI} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{IF} ]}_{γε} , \\ ∀ i ∈ {ℳ}^{EG} , ∀ j ∈ {ℳ}^{IF} , & ( 44 e ) \\ {\tilde{A}}_{ξ ( i ) ξ ( j )}^{II} = {\sum }_{γ , ε ∈ 𝒩} {( {\sum }_{α , β ∈ 𝒩} {[ {A}_{ξ ( i )}^{IF} ]}_{αβ} {W}_{αγ} {W}_{βε} ) [ {A}_{ξ ( j )}^{IF} ]}_{γε} , \\ ∀ i , j ∈ {ℳ}^{IF} , j \geq i . & ( 44 f )\end{matrix}$$

Let d₁ᵢ^{BL}(î), d₂ᵢ^{BL}(î), and d₃ᵢ^{BL}(î) denote the CPU times to compute Ã_{ξ(i)ξ(j)}^{BB}, for all i,jεM^{BL}, J≧i by EQS. (42), (43), and (44), respectively. Let d₁ᵢ^{EG}(î), d₂ᵢ^{EG}(î), and d₃ᵢ^{BG}(î) denote the CPU times to compute Ã_{ξ(i)ξ(j)}^{EE}, for all i,jεM^{EG}, j≧i by EQS. (42), (43), and (44), respectively. Let d₁ᵢ^{IF}(î), d₂ᵢ^{IF}(î), and d₃ᵢ^{IFG}(î) denote the CPU times to compute Ã_{ξ(i)ξ(j)}^{II}, for all i,jεM^{IF}, j≧i by EQS. (42), (43), and (44), respectively.

Define the following quantities:

$$\begin{matrix}{d}_{* i}^{BL} ( ξ ) = min \{ {d}_{1 i}^{BL} ( ξ ) , {d}_{2 i}^{BL} ( ξ ) , {d}_{3 i}^{BL} ( ξ ) \} , ∀ i ∈ {ℳ}^{BL} , & ( 45 a ) \\ {d}_{* i}^{EG} ( ξ ) = min \{ {d}_{1 i}^{EG} ( ξ ) , {d}_{2 i}^{EG} ( ξ ) , {d}_{3 i}^{EG} ( ξ ) \} , ∀ i ∈ {ℳ}^{EG} , & ( 45 b ) \\ {d}_{* i}^{IF} ( ξ ) = min \{ {d}_{1 i}^{IF} ( ξ ) , {d}_{2 i}^{IF} ( ξ ) , {d}_{3 i}^{IF} ( ξ ) \} , ∀ i ∈ {ℳ}^{IF} , & ( 45 c ) \\ {d}_{*} ( ξ ) = {\sum }_{i ∈ {ℳ}^{BL}} {d}_{* i}^{BL} ( ξ ) + {\sum }_{j ∈ {ℳ}^{EG}} {d}_{* j}^{BL} ( ξ ) + {\sum }_{𝓁 ∈ {ℳ}^{IF}} {d}_{* 𝓁}^{BL} ( ξ ) . & ( 45 d )\end{matrix}$$

The following proposition states that the minimum quantity d·(ξ) reaches its minimum if the index sets are sorted in descending order.

### Proposition 1:

(1) The permutation ξ* minimizes d·(ξ) over all ξεΞ and only if ξ* satisfies the following conditions:

η_{ξ*(1)}^{BL}≧η_{ξ*(2)}^{BL}≧ . . . ≧η_{ξ*(|M}^{BL}|)^{BL} (46a)

η_{ξ*(1)}^{EG}≧η_{ξ*(2)}^{EG}≧ . . . ≧η_{ξ*(|M}^{EG}|)^{EG} (46b)

η_{ξ*(1)}^{IF}≧η_{ξ*(2)}^{IF}≧ . . . ≧η_{ξ*(|M}^{IF}|)^{IF} (46c)

where ηᵢ^{BL}, ηᵢ^{EG}, ηᵢ^{IF} are the number of nonzero elements in Aᵢ^{BL}, for all iεM^{BL}, Aᵢ^{EG}, for all iεM^{EG}, and Aᵢ^{IF}, for all iεM^{IF}.

(2) If ξ satisfies EQS. (46), then there exists some indices q₁^{BL}, q₂^{BL}εM^{BL}, q₁^{BL}≦q₂^{BL}, q₁^{BG}, q₂^{EG}εM^{EG}, q₁^{EG}≦q₂^{EG}, and q₁^{IF}, q₂^{IF}εM^{IF}, q₁^{IF}≦q₂^{IF} such that

d₁ᵢ^{BL}(ξ)≦d₂ᵢ^{BL}(ξ),d₁ᵢ^{BL}(ξ)≦d₃ᵢ^{BL}(ξ) if 0<i≦q₁^{BL}, (47a)

d₂ᵢ^{BL}(ξ)<d₁ᵢ^{dL}(ξ),d₂ᵢ^{BL}(ξ)≦d₃ᵢ^{BL}(ξ) if q₁^{BL}<i≦q₂^{BL}, (47b)

d₃ᵢ^{BL}(ξ)<d₁ᵢ^{BL}(ξ),d₃ᵢ^{BL}(ξ)<d₂ᵢ^{BL}(ξ) if q₂^{BL}<i≦|M^{BL}|, (47c)

d₁ᵢ^{EG}(ξ)≦d₂ᵢ^{EG}(ξ),d₁ᵢ^{BL}(ξ)≦d₃ᵢ^{EG}(ξ) if 0<i≦q₁^{EG}, (47d)

d₂ᵢ^{EG}(ξ)<d₁ᵢ^{EG}(ξ),d₂ᵢ^{EG}(ξ)≦d₃ᵢ^{EG}(ξ) if q₂^{EG}<i≦q₂^{EG}, (47e)

d₃ᵢ^{EG}(ξ)<d₁ᵢ^{EG}(ξ),d₃ᵢ^{EG}(ξ)<d₂ᵢ^{EG}(ξ) if q₂^{EG}<i≦|M^{EG}|, (47f)

d₁ᵢ^{IF}(ξ)≦d₂ᵢ^{IF}(ξ),d₁ᵢ^{IF}(ξ)≦d₃ᵢ^{IF}(ξ) if 0<i≦q₁^{IF}, (47g)

d₂ᵢ^{IF}(ξ)<d₁ᵢ^{IF}(ξ),d₂ᵢ^{IF}(ξ)≦d₃ᵢ^{IF}(ξ) if q₁^{IF}<i≦q₂^{IF}, (47h)

d₃ᵢ^{IF}(ξ)<d₁ᵢ^{IF}(ξ),d₃ᵢ^{IF}(ξ)<d₂ᵢ^{IF}(ξ) if q₂^{IF}<i≦|M^{IF}|. (47i)

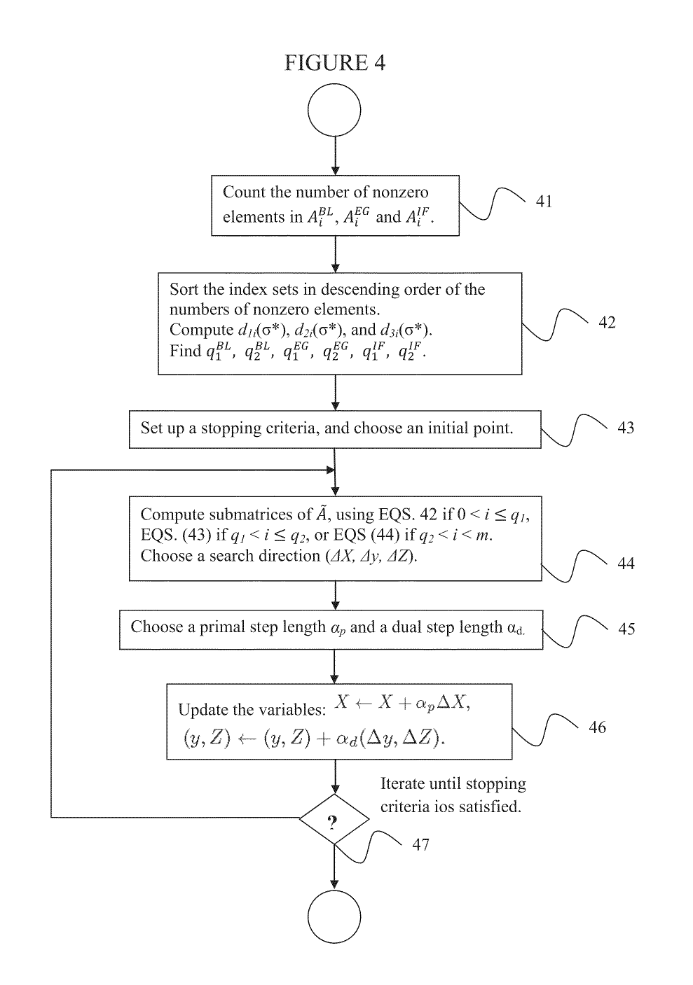

An enhanced procedure according to an embodiment of the disclosure that can exploit the sparsity structure of a smart-site energy management model according to an embodiment of the disclosure may be summarized as follows, with reference to the steps of the flowchart of FIG. 4:
(1) Count the number ηᵢ^{BL}, ηᵢ^{EG}, ηᵢ^{IF} of nonzero elements in Aᵢ^{BL}, for all iεM^{BL}, Aᵢ^{EG}, for all iεM^{EG}, and Aᵢ^{IF}, for all iεM^{IF} (Step 41).
(2) Sort the index sets M^{BL}, M^{EG}, M^{IF} in descending order of the numbers {ηᵢ^{BL}}, {ηᵢ^{EG}}, and {ηᵢ^{IF}} of nonzero elements in Aᵢ^{BL}, for all iεM^{BL}, Aᵢ^{BG}, for all iεM^{EG}, and Aᵢ^{IF}, for all iεM^{IF}, respectively. For each iεM^{BL}, compute d₁ᵢ^{BL}(ξ*), compute d₂ᵢ^{BL}(ξ*) and compute d₃ᵢ^{BL}(ξ*). Find q₁^{BL} and q₂₁^{BL} satisfying the second condition of Proposition 1. For each iεM^{EG}, compute d₁ᵢ^{BG}(ξ*), compute d₂ᵢ^{BG}(ξ*) and compute d³ⁱ_{BG}(ξ*). Find q₁^{EG} and q₂₁^{EG} satisfying the second condition of Proposition 1. For each iεM^{IF}, compute d₁ᵢ^{IF}(ξ*), compute d₂ᵢ^{IF}(ξ*) and compute d₂ᵢ^{IF}(ξ*). Find q₁^{IF} and q₂₁^{IF} satisfying the second condition of Proposition 1. (Step 42).
(3) Set up a stopping criteria, and choose an initial point (X⁰, y⁰, Z⁰) such that X⁰ [symbol] 0 and Z⁰ [symbol] 0. Set (X, y, Z)←(X⁰, y⁰, Z⁰) (Step 43).
(4) For every iεM^{BL}, compute Ã_{ξ*(i)ξ*(j)}^{BB}, for all j≧i, Ã_{ξ*(i)ξ*(j)}^{BE}, for all jεM^{EG}, Ã_{ξ*(i)ξ*(j)}^{BI}, for all jεM^{IF}, using EQS. (42) if 0<i≦q₁^{BL}, EQS. (43) if q₁^{BL}<i≦q₂^{BL}, or EQS. (44) otherwise; i.e. if q₁^{BL}<i<M^{BL}. For every iεM^{EG}, compute Ã_{ξ*(i)ξ*(j)}^{EE}, for all j≧i, Ã_{ξ*(i)ξ*(j)}^{EI}, for all jεM^{IF}, using EQS. (42) if 0<i≦q₁^{BG}, EQS. (43) if q₁^{EG}<i≦q₂^{EG}, or EQS. (44) otherwise; i.e. if q₂^{EG}<i<M^{EG}. For every iεM^{IF}, compute Ã_{ξ*(i)ξ*(j)}^{II}, for all j≧i, using EQS. (42) if 0<i≦q₁^{IF}, EQS. (43) if q₁^{IF}<i≦q₂^{IF}, or EQS. (44) otherwise; i.e. if q₂^{IF}<i<M^{IF}. Choose a search direction (ΔX, Δy, ΔZ) (Step 44).
(5) Choose a primal step length αₚ and a dual step length α_{d} such the following conditions hold (Step 45):

X+αₚΔX [symbol] 0, (48a)

Z+α_{d}ΔZ [symbol] 0. (48b)
(6) Update the variables (Step 46):

X←X+αₚΔX, (49a)

(y,Z)←(y,Z)+α_{d}(Δy,ΔZ). (49b)
(7) If the current iterate (X, y, Z) satisfies the stopping criteria, stop the iteration, otherwise go to step 4 (Step 47).

### System Implementations

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

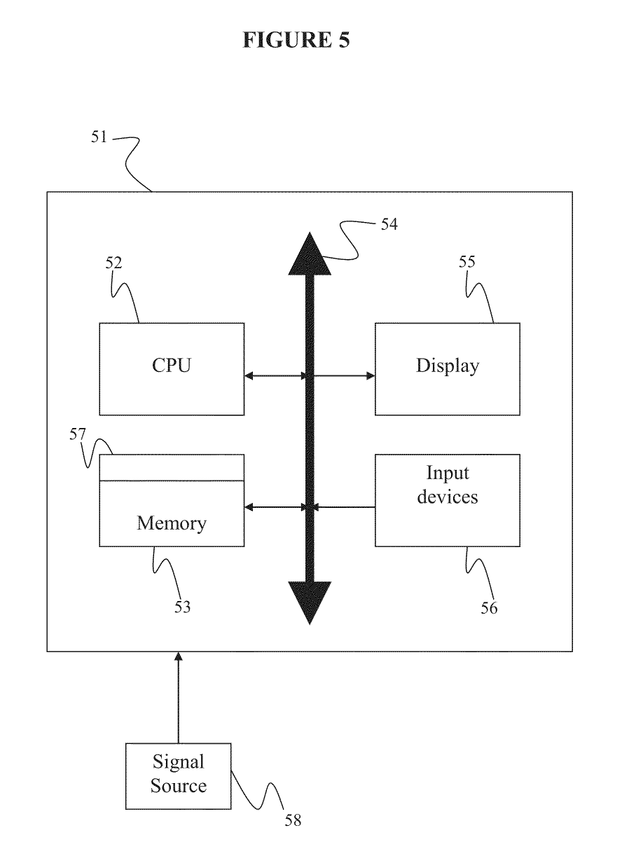

FIG. 5 is a block diagram of an exemplary computer system for implementing a method for a convex relaxation of a class of combined building-electric grid energy management models using a semidefinite programming (SDP) approach, according to an embodiment of the invention. Referring now to FIG. 5, a computer system 51 for implementing the present invention can comprise, inter alia, a central processing unit (CPU) 52, a memory 53 and an input/output (I/O) interface 54. The computer system 51 is generally coupled through the I/O interface 54 to a display 55 and various input devices 56 such as a mouse and a keyboard. The support circuits can include circuits such as cache, power supplies, clock circuits, and a communication bus. The memory 53 can include random access memory (RAM), read only memory (ROM), disk drive, tape drive, etc., or a combinations thereof. The present invention can be implemented as a routine 57 that is stored in memory 53 and executed by the CPU 52 to process the signal from the signal source 58. As such, the computer system 51 is a general purpose computer system that becomes a specific purpose computer system when executing the routine 57 of the present invention.

The computer system 51 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to exemplary embodiments, those skilled in the art will appreciate that various modifications and substitutions can be made thereto without departing from the spirit and scope of the invention as set forth in the appended claims.

### APPENDIX

### Nomenclature

The main notation used throughout the present paper is summarized below.

### Two-Letter Mnemonic of Energy Resources

BL Building.

BR Branch.

CD Condenser.

CG Chiller group.

CH Chiller.

CM Building group

DA Deaeretor.

EG Electric grid (excluding buildings)

GN Generator.

GS Gas

GT Gas turbine.

HR Heat recovery steam generator

IF Building-grid interface

LD Load

ND Node.

PM Pump.

ST Steam turbine.

TE Terminal.

TS Thermal energy storage (TES).

WR Water

### Parameters

π_{1gk}^{CG} Chilled water supply temperature of combined stream from all chillers (K)

π_{1ck}^{CD} Condenser i pressure 1 in Steam Loop (kPa)

π_{2ck}^{CD} Condenser i pressure 2 in Steam Loop (kPa)

π_{1ck}^{CH} Power consumed by chiller c condenser pumps (kW)

π_{2ck}^{CH} Power consumed by chiller c chilled water pumps (kW)

π_{3ck}^{CH} Power requirement by chiller c cooling tower fans (kW)

π₁ₘₖ^{CM} Cost of electricity purchase from grid by building group m at time k (S/KWh)

π₂ₘₖ^{CM} Electricity demand from building group m at time k (MW)

π₃ₘₖ^{CM} Cooling demand from building group m at time k (kW)

π_{1dk}^{DA} Deaerator d pressure in Steam Loop (kPa)

π_{1gk}^{GT} Ideal gas specific heat capacity of steam (KJ/kg-K)

π_{1gk}^{CT} Cost of fuel purchase for GT g at time k (S/kg)

π₁ₕₖ^{HR} Water stream pressure loss factor in HR h at time k

π₂ₕₖ^{HR} Overall effectiveness of HR h at time k

π₁ₛₖ^{ST} Overall efficiency of ST s at time k

π₁ₜₖ^{TS} Thermal transport delay time in discharging mode of TS t at time k (s)

π₂ₜₖ^{TS} TES thermal transport delay time in charging mode(s)

π₃ₜₖ^{TS} Time constant multiplier associated with TS upper layer in charging mode.

π₄ₜₖ^{TS} Time constant multiplier associated with TS upper layer in discharging mode.

π₅ₜₖ^{TS} Inter-layer heat transfer coefficient of TS in discharging mode (kW/m²-K)

π₆ₜₖ^{TS} Time constant multiplier associated with the TES bottom layer in discharging mode.

π₇ₜₖ^{TS} Inter-layer heat transfer coefficient of TES in discharging mode (kW/m²-K)

π₈ₜₖ^{TS} Time constant multiplier associated with the TES bottom layer in discharging mode.

π₉ₜₖ^{TS} Area of TES tank (m²)

π_{1wk}^{WR} Density of water (kg/s)

π_{2wk}^{WR} Enthalpy of vaporization of water.

π_{2wk}^{WR} Specific heat capacity of water (kJ/kg-K)

### Variables

x_{1gk}^{CG} Temperature of return water to chiller group g at time k (K)

x_{2gk}^{CG} Net chilled water mass flow rate through chiller group g at time k (kg/s)

x_{1ck}^{CG} Power requirement by chiller compressor c at time k (kW)

x_{2ck}^{CG} Supply water temperature from chiller c at time k (K)

x_{3ck}^{CG} Cooling provided by chiller c at time k (kW)

x_{4ck}^{CG} Chilled water mass flow rate in chiller c at time k (kg/s)

x₁ₘₖ^{CM} Chilled water flow rate through building group m at time k (kg/s)

x₂ₘₖ^{CM} Chilled water supply temperature to building group m at time k (K)

x₃ₘₖ^{CM} Temperature of return water from building group m at time k (K)

x₄ₘₖ^{CM} Mass flow rate of steam used for heating building group m at time k (kg/s)

x₅ₘₖ^{CM} Power purchase from electric grid by building group m at time k (MW)

x_{1gk}^{GN} Real-part power produced by generator g at time k, (MW)

x_{2gk}^{GN} Imaginary-part of power produced by generator g at time k, (MVAr)

x_{1gk}^{GT} Flow rate of exhaust gas of GT g at time k (kg/s)

x_{2gk}^{GT} Turbine exit temperature from GT g at time k (K)

x_{3gk}^{GT} Power produced by GT g at time k (MW)

x_{4gk}^{GT} Fuel consumption rate by GT g at time k (kg/s)

x₁ₕₖ^{HR} Inlet water temperature to HR h at time k (K)

x₂ₕₖ^{HR} Steam temperature exiting HR h at time k (K)

x₃ₕₖ^{HR} Saturation temperature in HR h at time k.

x₄ₕₖ^{HR} Gas temperature exiting HR h at time k (K)

x₅ₕₖ^{HR} Steam pressure exiting HR h at time k (kPa)

x₆ₕₖ^{HR} Saturation pressure in HR h at time k.

x₇ₕₖ^{HR} Steam pressure entering HR h at time k (kPa).

x₈ₕₖ^{HR} Water mass flow rate through HR h at time k (kg/s)

x₁ₗₖ^{LD} Real-part of power consumed by load l at time k, (MW)

x₂ₗₖ^{LD} Imaginary-part of power consumed by load l at time k, (MVAr)

x₁ₙₖ^{ND} Voltage magnitude at node n at time k, (p.u.)

x₂ₙₖ^{ND} Voltage angle at node n at time k, (radian)

x₁ₚₖ^{PM} Power consumption by pump p in steam loop at time k (kW)

x₁ₛₖ^{ST} Power produced by ST s at time k (MW)

x₂ₛₖ^{ST} Mass flow rate of steam used to drive ST s at time k (kg/s)

x₂ₛₖ^{ST} Fraction of cogenerated steam used to drive ST s at time k

x₁ₜₖ^{TE} Real-part of power flow at terminal t at time k, (MW)

x₂ₜₖ^{TE} Imaginary-part of power flow at terminal t at time k, (MVAr)

x₁ₜₖ^{TS} Top layer temperature in 2-zone model of TS t at time k (K)

x₂ₜₖ^{TS} Bottom layer temperature in 2-zone model of TS t at time k (K)

x₃ₜₖ^{TS} Inlet stream temperature in charging mode of TS t at time k (K)

x₄ₜₖ^{TS} Outlet stream temperature in charging mode of TS t at time k (K)

x₅ₜₖ^{TS} Outlet stream temperature in discharging mode of TS t at time k (K)

x₆ₜₖ^{TS} Inlet stream temperature in discharging mode of TS t at time k (K)

x₇ₜₖ^{TS} Chilled water circulation through TS t at time k (kg/s)

x₈ₜₖ^{TS} Outlet stream temperature in charging mode of TS t at time k, as predicted by detailed model (K)

x₉ₜₖ^{TS} Outlet stream temperature in discharging mode of TS t at time k, as predicted by detailed model (K)

What is claimed is:

1. A method for optimizing a cost of electric power generation in a smart site energy management model, comprising the steps of:
determining a matrix X that minimizes a semidefinite program
C·X−μln(det(X))
subject to constraints
A^{BL}(X)=b^{BL}
A^{EG}(X)=b^{EG},
A^{IF}(X)=b^{IF},
X [symbol] 0,
for positive real values of μ as μ approaches zero,
wherein C·X is a cost function that models a smart building-grid energy system of a plurality of buildings on a site interconnected with electric power grid energy resources wherein C is a matrix formed of parameters of components of a building model and an electric grid model, X is a matrix formed of decision variables of the building model and electric grid model, A^{BL}(X), A^{EG}(X), and A^{IF}(X) are sparse matrices that represent constraints due to a building (BL) model, an electric grid (EG) model, and an building-grid interface model (IF), respectively, in a semi-definite programming format, b^{BL}, b^{EG}, and b^{IF} are constants derived from the constraints of the building model and electric grid model; and
exploiting the sparsity of matrices A^{BL}(X), A^{EG}(X), and A^{IF}(X) in determining a search direction for determining the vector X.

2. The method of claim 1, wherein solving the primal semi-definite program comprises:
imposing optimality conditions on the primal semi-definite program to derive
C−Z−Ã^{BL}(y^{BL})−Ã^{EG}(y^{EG})−Ã^{IF}(y^{IF})=0
A^{BL}(X)−b^{BL}=0,
A^{EG}(X)−b^{EG}=0,
A^{IF}(X)−b^{IF}=0,
XZ−μI=0
wherein Z=μX⁻¹, X [symbol] 0, and Ã^{BL}(y^{BL}), Ã^{EG}(y^{EG}) and Ã^{IF} (y^{IF}) are transposes of A^{BL}(y^{BL}), A^{EG}(y^{EG}), and A^{IF}(y^{IF}) wherein y^{BL}, y^{EQ} and y^{IF} are variables in a dual program of the primal semi-definite program; and
choosing a search direction (ΔX, Δy, ΔZ) by solving
$$\tilde{A} Δ y = - \tilde{r} , \\ Δ Z = - {R}_{C} - {\sum }_{i ∈ {ℳ}_{b}} {A}_{bi}^{BL} Δ {y}_{i}^{BL} - {\sum }_{i ∈ {ℳ}_{e}} {A}_{i}^{EG} Δ {y}_{i}^{EG} - {\sum }_{i ∈ {ℳ}_{i}} {A}_{i}^{IF} Δ {y}_{i}^{IF} , \\ Δ X = ( K - W Δ Z ) W ,$$
wherein
$$W = {{X}^{\frac{1}{2}} ( {X}^{\frac{1}{2}} {ZX}^{\frac{1}{2}} )}^{- \frac{1}{2}} {X}^{\frac{1}{2}}$$
is a positive semidefinite symmetric matrix of order n, an
$$K = \frac{β}{n} ( X \cdot Z ) I - XZ$$
is an n×n real matrix that are determined by a current point (X, y, Z) for some βε(0,1),
wherein
$$\tilde{A} = [ \begin{matrix}{\tilde{A}}^{BB} & {\tilde{A}}^{BE} & {\tilde{A}}^{BI} \\ {( {\tilde{A}}^{BE} )}^{T} & {\tilde{A}}^{EE} & {\tilde{A}}^{EI} \\ {( {\tilde{A}}^{BI} )}^{T} & {( {\tilde{A}}^{EI} )}^{T} & {\tilde{A}}^{II}\end{matrix} ] , {\tilde{r}}_{b} = [ \begin{matrix}{\tilde{r}}_{b}^{BL} \\ {\tilde{r}}_{b}^{EG} \\ {\tilde{r}}_{b}^{IF}\end{matrix} ] . , \\ {\tilde{A}}_{ij}^{BB} = {WA}_{i}^{BL} W \cdot {A}_{j}^{BL} , ∀ i , j ∈ {ℳ}^{BL} , \\ {\tilde{A}}_{ij}^{BE} = {WA}_{i}^{BL} W \cdot {A}_{j}^{EG} , ∀ i ∈ {ℳ}^{BL} , ∀ j ∈ {ℳ}^{EG} , \\ {\tilde{A}}_{ij}^{BI} = {WA}_{i}^{BL} W \cdot {A}_{j}^{IF} , ∀ i ∈ {ℳ}^{BL} , ∀ j ∈ {ℳ}^{IF} , \\ {\tilde{A}}_{ij}^{EE} = {WA}_{i}^{EG} W \cdot {A}_{j}^{EG} , ∀ i , j ∈ {ℳ}^{EG} , \\ {\tilde{A}}_{ij}^{EI} = {WA}_{i}^{EG} W \cdot {A}_{j}^{IF} , ∀ i ∈ {ℳ}^{EG} , ∀ j ∈ {ℳ}^{IF} , \\ {\tilde{A}}_{ij}^{II} = {WA}_{i}^{IF} W \cdot {A}_{j}^{IF} , ∀ i , j ∈ {ℳ}^{IF} , \\ {\tilde{r}}_{{b}_{i}}^{BL} = {r}_{{b}_{i}}^{BL} + ( K + {WR}_{C} ) W \cdot {A}_{i}^{BL} , ∀ i ∈ {ℳ}^{BL} , \\ {\tilde{r}}_{{b}_{i}}^{EG} = {r}_{{b}_{i}}^{EG} + ( K + {WR}_{C} ) W \cdot {A}_{i}^{EG} , ∀ i ∈ {ℳ}^{EG} , \\ {\tilde{r}}_{{b}_{i}}^{IF} = {r}_{{b}_{i}}^{IF} + ( K + {WR}_{C} ) W \cdot {A}_{i}^{IF} , ∀ i ∈ {ℳ}^{IF} .$$
and M^{BL}, M^{EG}, and M^{IF} denote index sets of building, electric-grid and building-grid interface constraints, respectively.

3. The method of claim 2, further comprising:
initializing a solution (X, y, Z) to an initial point (X⁰, y⁰, Z⁰) wherein X⁰ [symbol] 0, Z⁰ [symbol] 0;
choosing a primal step length αₚ and a dual step length α_{d} that satisfy X+αₚΔX [symbol] 0 and Z+α_{d}ΔZ [symbol] 0;
updating X←X+αₚΔX and (y, Z)←α_{d}(Δy, ΔZ); and
repeating the steps of choosing a search direction, choosing a primal step length and a dual step length, and updating a current iterate (X, y, Z) until the current iterate satisfies a stopping condition.

4. The method of claim 2, further comprising enforcing linear independence constraint qualifications of the matrices Aᵢ^{BL}, for all iεM^{BL}, Aᵢ^{EG}, for all iεM^{EG}, and Aᵢ^{IF}, for all iεM^{If}.

5. The method of claim 2, wherein exploiting the sparsity of matrices A^{BL}(X), A^{EG}(X), and A^{IF}(X) comprises:
counting a number ηᵢ^{BL}, ηᵢ^{BG}, ηᵢ^{IF} of nonzero elements in Aᵢ^{BL}, for all iεM^{BL}, Aᵢ^{BG}, for all iεM^{EG}, and Aᵢ^{IF}, for all iεM^{IF},
sorting the index sets M^{BL}, M^{EG}, M^{IF} in descending order in the numbers {ηᵢ^{BL}}, {ηᵢ^{BG}}, and {ηᵢ^{IF}} of nonzero elements in, respectively, Aᵢ^{BL}, for all iεM^{BL}, Aᵢ^{EG}, for all iεM^{EG}, and Aᵢ^{IF}, for all iεM^{IF},
computing CPU times d₁ᵢ^{BL}(î), d₂ᵢ^{BL}(î), and d₃ᵢ^{BL}(î) needed to compute Ã_{ξ(i)ξ(j)}^{BB} for all i,jεM^{BL}, j≧i, wherein Ãᵢⱼ^{BB}=WAᵢ^{BL}W·Aⱼ^{BL},∀i,jεM^{BL}, and ξ represents a permutation of the indices of the union of M^{BL}, M^{EG}, M^{IF};
computing CPU times d₁ᵢ^{BG}(î), d₂ᵢ^{EG}(î), and d₃ᵢ^{EG}(î) needed to compute Ã_{ξ(i)ξ(j)}^{EE}, for all i,jεM^{EG}, j≧i, wherein Ãᵢⱼ=WAᵢ^{EG}W·Aⱼ^{EG}, ∀i,jεM^{EG};
computing CPU times d₁ᵢ^{IG}(î), d₂ᵢ^{IF}(î), and d₃ᵢ^{IGF}(î) needed to compute Ã_{ξ(i)ξ(j)}^{II}, for all i,jεM^{IF}, j≧i, wherein Ãᵢⱼ^{II}=WAᵢ^{IF}W·Aⱼ^{IF}, ∀i,jεM^{IF}; and
determining indices q₁^{BL}, q₂^{BL}εM^{BL}, q₁^{BL}≦q₂^{BL}, q₁^{EG}, q₂^{EG}εM^{EG}, q₁^{EG}≦q₂^{EG}, and q₁^{IF}, q₂^{IF}εM^{IF}, q₁^{IF}≦q₂^{IF} from conditions
d₁ᵢ^{BL}(ξ)≦d₂ᵢ^{BL}(ξ),d₁ᵢ^{BL}(ξ)≦d₃ᵢ^{BL}(ξ) if 0<i≦q₁^{BL},
d₂ᵢ^{BL}(ξ)<d₁ᵢ^{BL}(ξ),d₂ᵢ^{BL}(ξ)≦d₃ᵢ^{BL}(ξ) if q₁^{BL}<i≦q₂^{BL},
d₃ᵢ^{BL}(ξ)<d₁ᵢ^{BL}(ξ),d₃ᵢ^{BL}(ξ)<d₂ᵢ^{BL}(ξ) if q₂^{BL}<i≦|M^{BL}|,
d₁ᵢ^{EG}(ξ)≦d₂ᵢ^{EG}(ξ),d₁ᵢ^{EG}(ξ)≦d₃ᵢ^{EG}(ξ) if 0<i≦q₁^{EG},
d₂ᵢ^{EG}(ξ)<d₁ᵢ^{EG}(ξ),d₂ᵢ^{EG}(ξ)≦d₃ᵢ^{EG}(ξ) if q₁^{EG}<i≦q₂^{EG},
d₃ᵢ^{EG}(ξ)<d₁ᵢ^{EG}(ξ),d₃ᵢ^{EG}(ξ)<d₂ᵢ^{EG}(ξ) if q₂^{EG}<i≦|M^{EG}|,
d₁ᵢ^{IF}(ξ)≦d₂ᵢ^{IF}(ξ),d₁ᵢ^{IF}(ξ)≦d₃ᵢ^{IF}(ξ) if 0<i≦q₁^{IF},
d₂ᵢ^{IF}(ξ)<d₁ᵢ^{IF}(ξ),d₂ᵢ^{IF}(ξ)≦d₃ᵢ^{IF}(ξ) if q₁^{IF}<i≦q₂^{IF},
d₃ᵢ^{IF}(ξ)<d₁ᵢ^{IF}(ξ),d₃ᵢ^{IF}(ξ)<d₂ᵢ^{IF}(ξ) if q₂^{IF}<i≦|M^{IF}|.

6. The method of claim 5, wherein ξ minimizes
$${d}_{*} ( ξ ) = {\sum }_{i ∈ {ℳ}^{BL}} {d}_{* i}^{BL} ( ξ ) + {\sum }_{j ∈ {ℳ}^{EG}} {d}_{* j}^{BL} ( ξ ) + {\sum }_{𝓁 ∈ {ℳ}^{IF}} {d}_{* 𝓁}^{BL} ( ξ ) .$$
for a permutation of a union of the index sets M^{BL}, M^{EG}, and M^{IF}.

7. The method of claim 5, wherein
if 0<i≦q₁^{BL}, further comprising computing
Ã_{ξ(i)ξ(j)}^{BB}=G^{BL}·A_{ξ(j)}^{BL},∀i,jεM^{BL},j≧i,
Ã_{ξ(i)ξ(j)}^{BE}=G^{BL}·A_{ξ(j)}^{EG},∀iεM^{BL},∀jεM^{EG},
Ã_{ξ(i)ξ(j)}^{BI}=G^{VL}·A_{ξ(j)}^{IF},∀iεM^{BL},∀jεM^{IF},
if 0<i≦q₁^{BG}, further comprising computing
Ã_{ξ(i)ξ(j)}^{EE}=G^{EG}·A_{ξ(i)}^{EG},∀i,jεM^{EG},j≧i,
Ã_{ξ(i)ξ(j)}^{EI}=G^{EG}·A_{ξ(j)}^{IF},∀iεM^{EG},∀jεM^{IF},
and if 0<i≦q₁^{IF}, further comprising computing
Ã_{ξ(i)ξ(j)}^{II}=G^{IF}·A_{ξ(j)}^{IF},∀iεM^{IF},∀jεM^{IF},j≧i.

8. The method of claim 5, wherein
if q₁^{BL}<i≦q₂^{BL}, further comprising computing
$${\tilde{A}}_{ξ ( i ) ξ ( j )}^{BB} = {\sum }_{α ∈ 𝒩} {\sum }_{β ∈ 𝒩} {[ {A}_{ξ ( j )}^{BL} ]}_{αβ} ( {\sum }_{γ ∈ 𝒩} {{W}_{αγ} [ {F}_{i}^{BL} ]}_{γβ} ) , \\ ∀ i , j ∈ {ℳ}^{BL} , j \geq i , \\ {\tilde{A}}_{ξ ( i ) ξ ( j )}^{BE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{EG} , \\ {\tilde{A}}_{ξ ( i ) ξ ( j )}^{BI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{IF} ,$$
if q₁^{EG}<i≦q₂^{EG} further comprising computing
$${\tilde{A}}_{ξ ( i ) ξ ( j )}^{EE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{EG} ]}_{γβ} ) , \\ ∀ i , j ∈ {ℳ}^{EG} , j \geq i , \\ {\tilde{A}}_{ξ ( i ) ξ ( j )}^{EI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{EG} ]}_{γβ} ) , \\ ∀ i ∈ {ℳ}^{EG} , ∀ j ∈ {ℳ}^{IF} ,$$
and if q₁^{IF}<i≦q₂^{IF}, further comprising computing
$${\tilde{A}}_{ξ ( i ) ξ ( j )}^{II} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{IF} ]}_{γβ} ) , \\ ∀ i , j ∈ {ℳ}^{IF} , j \geq i .$$

9. The method of claim 5, wherein if q₂^{BL}<i<M^{BL}, further comprising computing
$${\tilde{A}}_{ξ ( i ) ξ ( j )}^{BB} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{BL} ]}_{γε} , \\ ∀ i , j ∈ {ℳ}^{BL} , j \geq i , \\ {\tilde{A}}_{ξ ( i ) ξ ( j )}^{BE} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{EG} ]}_{γε} , \\ ∀ i ∈ {ℳ}^{BL} , ∀ j ∈ {ℳ}^{EG} , \\ {\tilde{A}}_{ξ ( i ) ξ ( j )}^{BI} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{IF} ]}_{γε} , \\ ∀ i ∈ {ℳ}^{BL} , ∀ j ∈ {ℳ}^{IF} ,$$
if q₂^{EG}<i<M^{EG}, further comprising computing
$${\tilde{A}}_{ξ ( i ) ξ ( j )}^{EE} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{EG} ]}_{γε} , \\ ∀ i , j ∈ {ℳ}^{EG} , j \geq i , \\ {\tilde{A}}_{ξ ( i ) ξ ( j )}^{EI} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{IF} ]}_{γε} , \\ ∀ i ∈ {ℳ}^{EG} , ∀ j ∈ {ℳ}^{IF} ,$$
and if q₂^{IF}<i<M^{IF}, further comprising computing
$${\tilde{A}}_{ξ ( i ) ξ ( j )}^{II} = {\sum }_{γ , ε ∈ 𝒩} {( {\sum }_{α , β ∈ 𝒩} {[ {A}_{ξ ( i )}^{IF} ]}_{αβ} {W}_{αγ} {W}_{βε} ) [ {A}_{ξ ( j )}^{IF} ]}_{γε} , \\ ∀ i , j ∈ {ℳ}^{IF} , j \geq i .$$

10. A method for optimizing a cost of electric power generation in a smart site energy management model, comprising the steps of:
choosing a search direction (ΔX, Δy, ΔZ) to minimize a semi-definite program given by
C−Z−Ã^{BL}(y^{BL})−Ã^{EG}(y^{EG})−Ã^{IF}(y^{IF})=0
A^{BL}(X)−b^{BL}=0
A^{EG}(X)−b^{EG}=0
A^{IF}(X)−b^{IF}=0
XZ−μI=0
wherein C is a matrix formed of parameters of components of a building model and an electric grid model, X is a matrix formed of decision variables of the building model and electric grid model, A^{BL}(X), A^{EG}(X), and A^{IF}(X) are sparse matrices that represent constraints due to a building (BL) model, an electric grid (EG) model, and an building-grid interface model (IF), respectively, in a semi-definite programming format, b^{BL}, b^{EG}, and b^{IF} are constants derived from the constraints of the building model and electric grid model, Z=μX⁻¹, X [symbol] 0, and Ã^{BL}(y^{BL}), Ã^{EG}(y^{EG}) and Ã^{IF}(y^{IF}) are transposes of A^{BL}(y^{BL}), A^{EG}(y^{EG}), and A^{IF}(y^{IF}) wherein y^{BL}, y^{EQ}, and y^{IF} are variables in a dual program of the primal semi-definite program,
by solving
$$\tilde{A} Δ y = - \tilde{r} , \\ Δ Z = - {R}_{C} - {\sum }_{i ∈ {ℳ}_{b}} {A}_{bi}^{BL} Δ {y}_{i}^{BL} - {\sum }_{i ∈ {ℳ}_{e}} {A}_{i}^{EG} Δ {y}_{i}^{EG} - {\sum }_{i ∈ {ℳ}_{i}} {A}_{i}^{IF} Δ {y}_{i}^{IF} , \\ Δ X = ( K - W Δ Z ) W ,$$
wherein
$$W = {{X}^{\frac{1}{2}} ( {X}^{\frac{1}{2}} {ZX}^{\frac{1}{2}} )}^{- \frac{1}{2}} {X}^{\frac{1}{2}}$$
is a positive semidefinite symmetric matrix of order n, and
$$K = \frac{β}{n} ( X \cdot Z ) I - XZ$$
is an n×n real matrix that are determined by a current point (X, y, Z) for some βε(0,1),
wherein
$$\tilde{A} = [ \begin{matrix}{\tilde{A}}^{BB} & {\tilde{A}}^{BE} & {\tilde{A}}^{BI} \\ {( {\tilde{A}}^{BE} )}^{T} & {\tilde{A}}^{EE} & {\tilde{A}}^{EI} \\ {( {\tilde{A}}^{BI} )}^{T} & {( {\tilde{A}}^{EI} )}^{T} & {\tilde{A}}^{II}\end{matrix} ] , {\tilde{r}}_{b} = [ \begin{matrix}{\tilde{r}}_{b}^{BL} \\ {\tilde{r}}_{b}^{EG} \\ {\tilde{r}}_{b}^{IF}\end{matrix} ] . , \\ {\tilde{A}}_{ij}^{BB} = {WA}_{i}^{BL} W \cdot {A}_{j}^{BL} , ∀ i , j ∈ {ℳ}^{BL} , \\ {\tilde{A}}_{ij}^{BE} = {WA}_{i}^{BL} W \cdot {A}_{j}^{EG} , ∀ i ∈ {ℳ}^{BL} , ∀ j ∈ {ℳ}^{EG} , \\ {\tilde{A}}_{ij}^{BI} = {WA}_{i}^{BL} W \cdot {A}_{j}^{IF} , ∀ i ∈ {ℳ}^{BL} , ∀ j ∈ {ℳ}^{IF} , \\ {\tilde{A}}_{ij}^{EE} = {WA}_{i}^{EG} W \cdot {A}_{j}^{EG} , ∀ i , j ∈ {ℳ}^{EG} , \\ {\tilde{A}}_{ij}^{EI} = {WA}_{i}^{EG} W \cdot {A}_{j}^{IF} , ∀ i ∈ {ℳ}^{EG} , ∀ j ∈ {ℳ}^{IF} , \\ {\tilde{A}}_{ij}^{II} = {WA}_{i}^{IF} W \cdot {A}_{j}^{IF} , ∀ i , j ∈ {ℳ}^{IF} , \\ {\tilde{r}}_{{b}_{i}}^{BL} = {r}_{{b}_{i}}^{BL} + ( K + {WR}_{C} ) W \cdot {A}_{i}^{BL} , ∀ i ∈ {ℳ}^{BL} , \\ {\tilde{r}}_{{b}_{i}}^{EG} = {r}_{{b}_{i}}^{EG} + ( K + {WR}_{C} ) W \cdot {A}_{i}^{EG} , ∀ i ∈ {ℳ}^{EG} , \\ {\tilde{r}}_{{b}_{i}}^{IF} = {r}_{{b}_{i}}^{IF} + ( K + {WR}_{C} ) W \cdot {A}_{i}^{IF} , ∀ i ∈ {ℳ}^{IF} .$$
and M^{BL}, M^{EG}, and M^{IF} denote index sets of building, electric-grid and building-grid interface constraints, respectively; and
exploiting the sparsity of matrices A^{BL}(X), A^{EG}(X), and A^{IF}(X) in determining said search direction.

11. The method of claim 10, wherein said semi-definite program is derived by imposing optimality conditions on a primal semi-definite program
C·X−μln(det(X))
subject to constraints
A^{BL}(X)=b^{BL},
A^{EG}(X)=b^{EG},
A^{IF}(X)=b^{IF},
X [symbol] 0,
which is minimized for positive real values of μ as μ approaches zero.

12. A non-transitory program storage device readable by a computer, tangibly embodying a program of instructions executed by the computer to perform the method steps for optimizing a cost of electric power generation in a smart site energy management model, the method comprising the steps of:
determining a matrix X that minimizes a semidefinite program
C·X−μln(det(X))
subject to constraints
A^{BL}(X)=b^{BL},
A^{EG}(X)=b^{EG},
A^{IF}(X)=b^{IF},
X [symbol] 0
for positive real values of μ as μ approaches zero,
wherein C·X is a cost function that models a smart building-grid energy system of a plurality of buildings on a site interconnected with electric power grid energy resources wherein C is a matrix formed of parameters of components of a building model and an electric grid model, X is a matrix formed of decision variables of the building model and electric grid model, A^{BL}(X), A^{EG}(X), and A^{IF}(X) are sparse matrices that represent constraints due to a building (BL) model, an electric grid (EG) model, and an building-grid interface model (IF), respectively, in a semi-definite programming format, b^{BL}, b^{EG}, and b^{IF} are constants derived from the constraints of the building model and electric grid model; and
exploiting the sparsity of matrices A^{BL}(X), A^{EG}(X), and A^{IF}(X) in determining a search direction for determining the vector X.

13. The computer readable program storage device of claim 12, wherein solving the primal semi-definite program comprises:
imposing optimality conditions on the primal semi-definite program to derive
C−Z−Ã^{BL}(y^{BL})−Ã^{EG}(y^{EG})−Ã^{IF}(y^{IF})=0,
A^{BL}(X)−b^{BL}=0
A^{EG}(X)−b^{EG}=0
A^{IF}(X)−b^{IF}=0,
XZ−μI=0
wherein Z=μX⁻¹, X [symbol] 0, and Ã^{BL}(y^{BL}) Ã^{EG}(y^{EG}) and Ã^{IF}(y^{IF}) are transposes of A^{BL}(y^{BL}), A^{EG}(y^{EG}), and A^{IF}(y^{IF}) wherein y^{BL}, y^{EQ}, and y^{IF} are variables in a dual program of the primal semi-definite program; and
choosing a search direction (ΔX, Δy, ΔZ) by solving
$$\tilde{A} Δ y = - \tilde{r} , \\ Δ Z = - {R}_{C} - {\sum }_{i ∈ {ℳ}_{b}} {A}_{bi}^{BL} Δ {y}_{i}^{BL} - {\sum }_{i ∈ {ℳ}_{e}} {A}_{i}^{EG} Δ {y}_{i}^{EG} - {\sum }_{i ∈ {ℳ}_{i}} {A}_{i}^{IF} Δ {y}_{i}^{IF} , \\ Δ X = ( K - W Δ Z ) W ,$$
wherein
$$W = {{X}^{\frac{1}{2}} ( {X}^{\frac{1}{2}} {ZX}^{\frac{1}{2}} )}^{- \frac{1}{2}} {X}^{\frac{1}{2}}$$
is a positive semidefinite symmetric matrix of order n, and
$$K = \frac{β}{n} ( X \cdot Z ) I - XZ$$
is an n×n real matrix that are determined by a current point (X, y, Z) for some βε(0,1),
wherein
$$\tilde{A} = [ \begin{matrix}{\tilde{A}}^{BB} & {\tilde{A}}^{BE} & {\tilde{A}}^{BI} \\ {( {\tilde{A}}^{BE} )}^{T} & {\tilde{A}}^{EE} & {\tilde{A}}^{EI} \\ {( {\tilde{A}}^{BI} )}^{T} & {( {\tilde{A}}^{EI} )}^{T} & {\tilde{A}}^{II}\end{matrix} ] , {\tilde{r}}_{b} = [ \begin{matrix}{\tilde{r}}_{b}^{BL} \\ {\tilde{r}}_{b}^{EG} \\ {\tilde{r}}_{b}^{IF}\end{matrix} ] . , \\ {\tilde{A}}_{ij}^{BB} = {WA}_{i}^{BL} W \cdot {A}_{j}^{BL} , ∀ i , j ∈ {ℳ}^{BL} , \\ {\tilde{A}}_{ij}^{BE} = {WA}_{i}^{BL} W \cdot {A}_{j}^{EG} , ∀ i ∈ {ℳ}^{BL} , ∀ j ∈ {ℳ}^{EG} , \\ {\tilde{A}}_{ij}^{BI} = {WA}_{i}^{BL} W \cdot {A}_{j}^{IF} , ∀ i ∈ {ℳ}^{BL} , ∀ j ∈ {ℳ}^{IF} , \\ {\tilde{A}}_{ij}^{EE} = {WA}_{i}^{EG} W \cdot {A}_{j}^{EG} , ∀ i , j ∈ {ℳ}^{EG} , \\ {\tilde{A}}_{ij}^{EI} = {WA}_{i}^{EG} W \cdot {A}_{j}^{IF} , ∀ i ∈ {ℳ}^{EG} , ∀ j ∈ {ℳ}^{IF} , \\ {\tilde{A}}_{ij}^{II} = {WA}_{i}^{IF} W \cdot {A}_{j}^{IF} , ∀ i , j ∈ {ℳ}^{IF} , \\ {\tilde{r}}_{{b}_{i}}^{BL} = {r}_{{b}_{i}}^{BL} + ( K + {WR}_{C} ) W \cdot {A}_{i}^{BL} , ∀ i ∈ {ℳ}^{BL} , \\ {\tilde{r}}_{{b}_{i}}^{EG} = {r}_{{b}_{i}}^{EG} + ( K + {WR}_{C} ) W \cdot {A}_{i}^{EG} , ∀ i ∈ {ℳ}^{EG} , \\ {\tilde{r}}_{{b}_{i}}^{IF} = {r}_{{b}_{i}}^{IF} + ( K + {WR}_{C} ) W \cdot {A}_{i}^{IF} , ∀ i ∈ {ℳ}^{IF} .$$
and M^{BL}, M^{EG}, and M^{IF} denote index sets of building, electric-grid and building-grid interface constraints, respectively.

14. The computer readable program storage device of claim 13, the method further comprising:
initializing a solution (X, y, Z) to an initial point (X⁰, y⁰, Z⁰) wherein X⁰ [symbol] 0, Z⁰ [symbol] 0;
choosing a primal step length αₚ and a dual step length α_{d} that satisfy X+αₚΔX [symbol] 0 and Z+α_{d}ΔZ [symbol] 0;
updating X←X+αₚΔX and (y, Z)←α_{d}(Δy, ΔZ); and
repeating the steps of choosing a search direction, choosing a primal step length and a dual step length, and updating a current iterate (X, y, Z) until the current iterate satisfies a stopping condition.

15. The computer readable program storage device of claim 13, the method further comprising enforcing linear independence constraint qualifications of the matrices Aᵢ^{BL}, for all iεM^{BL}, Aᵢ^{EG}, for all iεM^{EG}, and Aᵢ^{IF}, for all iεM^{IF}.

16. The computer readable program storage device of claim 13, wherein exploiting the sparsity of matrices A^{BL}(X), A^{EG}(X), and A^{IF}(X) comprises:
counting a number ηᵢ^{BL}, ηᵢ^{EG}, ηᵢ^{IF} of nonzero elements in Aᵢ^{BL}, for all iεM^{BL}, Aᵢ^{EG}, for all iεM^{EG}, and Aᵢ^{IF}, for all iεM^{IF},
sorting the index sets M^{BL}, M^{EG}, M^{IF} in descending order in the numbers {ηᵢ^{BL}}, {ηᵢ^{EG}}, and {ηᵢ^{IF}} of nonzero elements in, respectively, Aᵢ^{BL}, for all iεM^{BL}, Aᵢ^{EG}, for all iεM^{EG}, and Aᵢ^{IF}, for all iεM^{IF},
computing CPU times d₁ᵢ^{BL}(î), d₂ᵢ^{BL}(î), and d₃ᵢ^{BL}(î) needed to compute Ã_{ξ(i)ξ(j)}^{BB} for all i,jεM^{BL}, j≧i, wherein Ãᵢⱼ^{BB}=WAᵢ^{BL}W·Aⱼ^{BL}, ∀i,jεM^{BL}, and ξ represents a permutation of the indices of the union of M^{BL}, M^{EG}, M^{IF};
computing CPU times d₁ᵢ^{EG}(î), d₂ᵢ^{EG}(î), and d₃ᵢ^{EG}(î) needed to compute Ã_{ξ(i)ξ(j)}^{EE}, for all i,jεM^{EG}, j≧i, wherein Ãᵢⱼ^{EE}=WAᵢ^{EG}W·Aⱼ^{EG}, ∀i,jεM^{EG};
computing CPU times d_{1f}^{IF}(î), d₂ᵢ^{IF}(î), and d₃ᵢ^{IGF}(î) needed to compute Ã_{ξ(i)ξ(j)}^{II}, for all i,jεM^{IF}, j≧i, wherein Ãᵢⱼ^{II}=WAᵢ^{IF}W·Aⱼ^{IF}, ∀i,jεM^{IF}; and
determining indices q₁^{BL}, q₂^{BL}εM^{BL}, q₁^{BL}≦q₂^{BL}, q₁^{EG}, q₂^{BG}εM^{EG},q₁^{EG}≦q₂^{EG}, and q₁^{IF}, q₂^{IF}εM^{IF},q₁^{IF}≦q₂^{IF} from conditions
d₁ᵢ^{BL}(ξ)≦d₂ᵢ^{BL}(ξ),d₁ᵢ^{BL}(ξ)≦d₃ᵢ^{BL}(ξ) if 0<i≦q₁^{BL},
d₂ᵢ^{BL}(ξ)<d₁ᵢ^{BL}(ξ),d₂ᵢ^{BL}(ξ)≦d₃ᵢ^{BL}(ξ) if q₁^{BL}<i≦q₂^{BL},
d₃ᵢ^{BL}(ξ)<d₁ᵢ^{BL}(ξ),d₃ᵢ^{BL}(ξ)<d₂ᵢ^{BL}(ξ) if q₂^{BL}<i≦|M^{BL}|,
d₁ᵢ^{EG}(ξ)≦d₂ᵢ^{EG}(ξ),d₁ᵢ^{EG}(ξ)≦d₃ᵢ^{EG}(ξ) if 0<i≦q₁^{EG},
d₂ᵢ^{EG}(ξ)<d₁ᵢ^{EG}(ξ),d₂ᵢ^{EG}(ξ)≦d₃ᵢ^{EG}(ξ) if q₁^{EG}<i≦q₂^{EG},
d₃ᵢ^{EG}(ξ)<d₁ᵢ^{EG}(ξ),d₃ᵢ^{EG}(ξ)<d₂ᵢ^{EG}(ξ) if q₂^{EG}<i≦|M^{EG}|,
d₁ᵢ^{IF}(ξ)≦d₂ᵢ^{IF}(ξ),d₁ᵢ^{IF}(ξ)≦d₃ᵢ^{IF}(ξ) if 0<i≦q₁^{IF},
d₂ᵢ^{IF}(ξ)<d₁ᵢ^{IF}(ξ),d₂ᵢ^{IF}(ξ)≦d₃ᵢ^{IF}(ξ) if q₁^{IF}<i≦q₂^{IF},
d₃ᵢ^{IF}(ξ)<d₁ᵢ^{IF}(ξ),d₃ᵢ^{IF}(ξ)<d₂ᵢ^{IF}(ξ) if q₂^{IF}<i≦|M^{IF}|,

17. The computer readable program storage device of claim 16, wherein ξ minimizes
$${d}_{*} ( ξ ) = {\sum }_{i ∈ {ℳ}^{BL}} {d}_{* i}^{BL} ( ξ ) + {\sum }_{j ∈ {ℳ}^{EG}} {d}_{* j}^{BL} ( ξ ) + {\sum }_{𝓁 ∈ {ℳ}^{IF}} {d}_{* 𝓁}^{BL} ( ξ ) .$$
for a permutation of a union of the index sets M^{BL}, M^{EG}, and M^{IF}.

18. The computer readable program storage device of claim 16, wherein
if 0<i≦qᵢ^{BL}, the method further comprises computing
Ã_{ξ(i)ξ(j)}^{BB}=G^{BL}·A_{ξ(j)}^{BL},∀i,jεM^{BL},j≧i,
Ã_{ξ(i)ξ(j)}^{BE}=G^{BL}·A_{ξv(j)}^{EG},∀iεM^{BL},∀jεM^{EG},
Ã_{ξ(i)ξ(j)}^{BI}=G^{VL}·A_{ξ(j)}^{IF},∀iεM^{BL},∀jεM^{IF},
if 0<i≦q₁^{EG}, the method further comprises computing
Ã_{ξ(i)ξ(j)}^{EE}=G^{EG}·A_{ξ(i)}^{EG},∀i,jεM^{EG},j≧i,
Ã_{ξ(i)ξ(j)}^{EI}=G^{EG}·A_{ξ(j)}^{IF},∀iεM^{EG},∀jεM^{IF},
and if 0<i≦qᵢ^{IF}, the method further comprises computing
Ã_{ξ(i)ξ(j)}^{II}=G^{IF}·A_{ξ(j)}^{IF},∀iεM^{IF},∀jεM^{IF},j≧i.

19. The computer readable program storage device of claim 16, wherein
if q₁^{BL}<i≦q₂^{BL}, the method further comprises computing
$${\tilde{A}}_{ξ ( i ) ξ ( j )}^{BB} = {\sum }_{α ∈ 𝒩} {\sum }_{β ∈ 𝒩} {[ {A}_{ξ ( j )}^{BL} ]}_{αβ} ( {\sum }_{γ ∈ 𝒩} {{W}_{αγ} [ {F}_{i}^{BL} ]}_{γβ} ) , \\ ∀ i , j ∈ {ℳ}^{BL} , j \geq i , \\ {\tilde{A}}_{ξ ( i ) ξ ( j )}^{BE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{EG} , \\ {\tilde{A}}_{ξ ( i ) ξ ( j )}^{BI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{BL} ]}_{γβ} ) , \\ ∀ i ∈ {ℳ}^{BL} , ∀ j ∈ {ℳ}^{IF} ,$$
if q₁^{BG}<i≦q₁^{EG}, the method further comprises computing
$${\tilde{A}}_{ξ ( i ) ξ ( j )}^{EE} = {\sum }_{α ∈ 𝒩} {\sum }_{β ∈ 𝒩} {[ {A}_{ξ ( j )}^{EG} ]}_{αβ} ( {\sum }_{γ ∈ 𝒩} {{W}_{αγ} [ {F}_{i}^{EG} ]}_{γβ} ) , \\ ∀ i , j ∈ {ℳ}^{EG} , j \geq i , \\ {\tilde{A}}_{ξ ( i ) ξ ( j )}^{EI} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{EG} ]}_{γβ} ) , \\ ∀ i ∈ {ℳ}^{EG} , ∀ j ∈ {ℳ}^{IF} ,$$
and if q₁^{IF}<i≦q₂^{IF}, the method further comprises computing
$${\tilde{A}}_{ξ ( i ) ξ ( j )}^{II} = {\sum }_{α ∈ 𝒩} {\sum }_{β ∈ 𝒩} {[ {A}_{ξ ( j )}^{IF} ]}_{αβ} ( {\sum }_{γ ∈ 𝒩} {{W}_{αγ} [ {F}_{i}^{IF} ]}_{γβ} ) , \\ ∀ i , j ∈ {ℳ}^{IF} , j \geq i .$$

20. The computer readable program storage device of claim 16, wherein
if q₁^{BL}<i<M^{BL}, the method further comprises computing
$${\tilde{A}}_{ξ ( i ) ξ ( j )}^{BB} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{BL} ]}_{γε} , \\ ∀ i , j ∈ {ℳ}^{BL} , j \geq i , \\ {\tilde{A}}_{ξ ( i ) ξ ( j )}^{BE} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{EG} ]}_{γε} , \\ ∀ i ∈ {ℳ}^{BL} , ∀ j ∈ {ℳ}^{EG} , \\ {\tilde{A}}_{ξ ( i ) ξ ( j )}^{BI} = {\sum }_{γ , ε ∈ 𝒩} {( {\sum }_{α , β ∈ 𝒩} {[ {A}_{ξ ( i )}^{BL} ]}_{αβ} {W}_{αγ} {W}_{βε} ) [ {A}_{ξ ( j )}^{IF} ]}_{γε} , \\ ∀ i ∈ {ℳ}^{BL} , ∀ j ∈ {ℳ}^{IF} ,$$
if q₂^{EG}<i<M^{EG}, the method further comprises computing
$${\tilde{A}}_{ξ ( i ) ξ ( j )}^{EE} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{EG} ]}_{γε} , \\ ∀ i , j ∈ {ℳ}^{EG} , j \geq i , \\ {\tilde{A}}_{ξ ( i ) ξ ( j )}^{EI} = {\sum }_{γ , ε ∈ 𝒩} {( {\sum }_{α , β ∈ 𝒩} {[ {A}_{ξ ( i )}^{EG} ]}_{αβ} {W}_{αγ} {W}_{βε} ) [ {A}_{ξ ( j )}^{IF} ]}_{γε} , \\ ∀ i ∈ {ℳ}^{EG} , ∀ j ∈ {ℳ}^{IF} ,$$
and if q₂^{IF}<i<M^{IF}, the method further comprises computing
$${\tilde{A}}_{ξ ( i ) ξ ( j )}^{II} = {\sum }_{γ , ε ∈ 𝒩} {( {\sum }_{α , β ∈ 𝒩} {[ {A}_{ξ ( i )}^{IF} ]}_{αβ} {W}_{αγ} {W}_{βε} ) [ {A}_{ξ ( j )}^{IF} ]}_{γε} , \\ ∀ i , j ∈ {ℳ}^{IF} , j \geq i .$$
